(19) United States
(12) Patent Application Publication
(10) Pub. No.: US 2026/0004707 A1
(43) Pub. Date: Jan. 1, 2026

(54) DRIVING METHOD OF DISPLAY PANEL AND DISPLAY DEVICE

(71) Applicant: Tianma Advanced Display Technology Institute (Xiamen) Co., Ltd., Xiamen (CN)

(72) Inventor: Yingteng ZHAI, Xiamen (CN)

(21) Appl. No.: 18/893,590

(22) Filed: Sep. 23, 2024

(30) Foreign Application Priority Data
Jun. 28, 2024 (CN) 202410864775.7

(51) Int. Cl. G09G 3/32

(52) U.S. Cl. CPC G09G 3/32; G09G 2300/0852; G09G 2310/027; G09G 2320/0233; G09G 2320/0673

(57) ABSTRACT

Driving method of display panel and display device are provided. The display panel includes a plurality of light-emitting devices and a plurality of pixel circuits. A frame of the display panel including at least one subframe. A working process of a pixel circuit of the plurality of pixel circuits in a subframe of the at least one subframe includes a luminescence stage. The display panel includes a first luminance mode and a second luminance mode. The driving method includes that in both the first luminance mode and the second luminance mode, a light-emitting device of the plurality of light-emitting devices is controlled to display gray levels according to an instantaneous luminance allocation rule for a subframe. A maximum duration of the luminescence stage in subframes in the first luminance mode is greater than a maximum duration of the luminescence stage in subframes in the second luminance mode.

### CROSS-REFERENCE TO RELATED APPLICATION

This application claims priority of Chinese Patent Application No. 202410864775.7, filed on Jun. 28, 2024, the entire contents of which are hereby incorporated by reference.

### FIELD OF THE DISCLOSURE

The present disclosure generally relates to the field of display technology and, more particularly, relates to a driving method of a display panel and a display device.

### BACKGROUND

A Micro-light-emitting diode (Micro-LED) has characteristics of miniaturization, high photoelectric conversion efficiency, and short response time. Micro-LED is expected to become a next-generation display technology after organic light-emitting semiconductor (OLED). A display panel generally includes a luminance adjustment function to suit different application scenarios. For example, a high-luminance mode is used for displays in well-lit outdoor environments, while a low-luminance mode is used for indoor displays. When Micro-LED display panels use traditional methods to adjust luminance, efficiency and uniformity thereof may be affected.

### BRIEF SUMMARY OF THE DISCLOSURE

One aspect of the present disclosure provides a driving method of a display panel. The display panel includes a plurality of light-emitting devices and a plurality of pixel circuits, a frame of the display panel including at least one subframe, and a working process of a pixel circuit of the plurality of pixel circuits in a subframe of the at least one subframe at least includes a luminescence stage. the display panel operates in a first luminance mode and a second luminance mode, when the display panel displays a same gray level, a luminance of the display panel in the first luminance mode is greater than a luminance of the display panel in the second luminance mode. The driving method includes that in the first luminance mode, the frame of the display panel includes N subframes, where N is an integer, and N≥2, in the first luminance mode, a light-emitting device of the plurality of light-emitting devices is controlled to display gray levels according to an instantaneous luminance allocation rule for a subframe within the N subframes; the instantaneous luminance allocation rule for the subframe includes that a gray level of the gray levels displayed by the light-emitting device increases as an instantaneous luminance of the light-emitting device in the subframe increases; and in the second luminance mode, the frame of the display panel includes M subframes, where M is an integer, and N≥M≥1, in the second luminance mode, a light-emitting device of the plurality of light-emitting devices is controlled to display gray levels according to the instantaneous luminance allocation rule for the subframe, a maximum duration of the luminescence stage in the N subframes in the first luminance mode is t10, and t10 is greater than a maximum duration of the luminescence stage in the M subframes in the second luminance mode.

Another aspect of the present disclosure provides another driving method of a display panel. The display panel includes a plurality of light-emitting devices and a plurality of pixel circuits, the plurality of pixel circuits includes a first driving circuit and a second driving circuit, the first driving circuit is configured to control a duration of providing a driving current to the light emitting device based on a first data voltage, the second driving circuit is configured to control an amplitude of the driving current provided to a light emitting device of the plurality of light-emitting devices based on a second data voltage and in a frame of the display panel, a working process of a pixel circuit of the plurality of pixel circuits includes a writing stage and a luminescence stage. The display panel operates in a first luminance mode and a second luminance mode, and when a same gray level is displayed, a luminance of the display panel in the first luminance mode is greater than a luminance of the display panel in the second luminance mode, the plurality of light-emitting devices includes a first color light-emitting device. The driving method includes that in the first luminance mode, when the first color light-emitting device displays a maximum gray level, a first data voltage written in the writing stage is PWM-data11, a second data voltage written is PAM-data1, and an effective luminescence duration of the luminescence stage is t31, in the first luminance mode, a light-emitting device of the plurality of light-emitting devices is controlled to display gray levels according to a gray level allocation rule, the gray level allocation rule includes that the second data voltage written in the writing stage is fixed, and a gray level of the gray levels displayed by the light-emitting device changes with a change of the first data voltage; and in the second luminance mode, when the first color light-emitting device displays the maximum gray level, the first data voltage written in the writing stage is PWM-data21, the second data voltage written is PAM-data2, and the effective luminescence duration of the luminescence stage is t41, a light-emitting device of the plurality of light-emitting devices is controlled to display gray levels according to the gray level allocation rule in the second luminance mode, where PWM-data21≠PWM-data11, PAM-data2=PAM-data1, and t41<t31.

Another aspect of the present disclosure provides a display device including a display panel. The display panel includes a plurality of light-emitting devices and a plurality of pixel circuits, a frame of the display panel including at least one subframe, and a working process of a pixel circuit of the plurality of pixel circuits in a subframe of the at least one subframe at least includes a luminescence stage. the display panel operates in a first luminance mode and a second luminance mode, when the display panel displays a same gray level, a luminance of the display panel in the first luminance mode is greater than a luminance of the display panel in the second luminance mode. A driving method of the display panel includes that in the first luminance mode, the frame of the display panel includes N subframes, where N is an integer, and N≥2, in the first luminance mode, a light-emitting device of the plurality of light-emitting devices is controlled to display gray levels according to an instantaneous luminance allocation rule for a subframe within the N subframes; the instantaneous luminance allocation rule for the subframe includes that a gray level of the gray levels displayed by the light-emitting device increases as an instantaneous luminance of the light-emitting device in the subframe increases; and in the second luminance mode, the frame of the display panel includes M subframes, where M is an integer, and N≥M≥1, in the second luminance mode, a light-emitting device of the plurality of light-emitting devices is controlled to display gray levels according to the instantaneous luminance allocation rule for the subframe, a maximum duration of the luminescence stage in the N subframes in the first luminance mode is t10, and t10 is greater than a maximum duration of the luminescence stage in the M subframes in the second luminance mode.

Other aspects of the present disclosure can be understood by a person skilled in the art in light of the description, the claims, and the accompanying drawings of the present disclosure.

### BRIEF DESCRIPTION OF THE DRAWINGS

To more clearly explain embodiments of the present disclosure or technical solutions in the art, the accompanying drawings needed to be used in the description of the embodiments, or the art will be briefly described below. Obviously, a person skilled in the art can acquire other drawings according to the accompanying drawings without any creative efforts.

FIG. 1 illustrates a schematic diagram of a pixel circuit consistent with various embodiments of the present disclosure;

FIG. 2 illustrates a schematic diagram of another pixel circuit consistent with various embodiments of the present disclosure;

FIG. 3 illustrates a distribution diagram of instantaneous luminance and gray levels in a subframe;

FIG. 4 illustrates a comparison diagram of a first luminance mode and a first sub-luminance mode consistent with various embodiments of the present disclosure;

FIG. 5 illustrates another comparison diagram of a first luminance mode and a first sub-luminance mode consistent with various embodiments of the present disclosure;

FIG. 6 illustrates another comparison diagram of a first luminance mode and a first sub-luminance mode consistent with various embodiments of the present disclosure;

FIG. 7 illustrates another comparison diagram of a first luminance mode and a first sub-luminance mode consistent with various embodiments of the present disclosure;

FIG. 8 illustrates a timing comparison diagram of a first luminance mode and a second luminance mode consistent with various embodiments of the present disclosure;

FIG. 9 illustrates another timing comparison diagram of a first luminance mode and a second luminance mode consistent with various embodiments of the present disclosure;

FIG. 10 illustrates a comparison diagram of a first luminance mode and a second sub-luminance mode consistent with various embodiments of the present disclosure;

FIG. 11 illustrates a comparison diagram of a second sub-luminance mode and a third sub-luminance mode consistent with various embodiments of the present disclosure;

FIG. 12 illustrates a comparison diagram of a second sub-luminance mode and a fourth sub-luminance mode consistent with various embodiments of the present disclosure;

FIG. 13 illustrates a comparison diagram of a fourth sub-luminance mode and a fifth sub-luminance mode consistent with various embodiments of the present disclosure;

FIG. 14 illustrates another timing comparison diagram of a first luminance mode and a second luminance mode consistent with various embodiments of the present disclosure;

FIG. 15 illustrates another timing comparison diagram of a first luminance mode and a second luminance mode consistent with various embodiments of the present disclosure;

FIG. 16 illustrates a schematic diagram of a driving method consistent with various embodiments of the present disclosure;

FIG. 17 illustrates a schematic diagram of a subframe status in a first mode consistent with various embodiments of the present disclosure;

FIG. 18 illustrates a schematic diagram of another subframe status in a first mode consistent with various embodiments of the present disclosure;

FIG. 19 illustrates a comparison diagram of a first sub-mode and a second sub-mode consistent with various embodiments of the present disclosure;

FIG. 20 illustrates another comparison diagram of a first sub-mode and a second sub-mode consistent with various embodiments of the present disclosure;

FIG. 21 illustrates another comparison diagram of a first sub-mode and a second sub-mode consistent with various embodiments of the present disclosure;

FIG. 22 illustrates another comparison diagram of a first sub-mode and a second sub-mode consistent with various embodiments of the present disclosure;

FIG. 23 illustrates a schematic diagram of another pixel circuit consistent with various embodiments of the present disclosure;

FIG. 24 illustrates a timing diagram of the pixel circuit provided for an embodiment illustrated in FIG. 23;

FIG. 25 illustrates a schematic diagram of another pixel circuit consistent with various embodiments of the present disclosure;

FIG. 26 illustrates a comparison diagram of a first luminance mode and a second luminance mode consistent with various embodiments of the present disclosure;

FIG. 27 illustrates another comparison diagram of a first luminance mode and a second luminance mode consistent with various embodiments of the present disclosure;

FIG. 28 illustrates a comparison diagram of three luminance modes consistent with various embodiments of the present disclosure;

FIG. 29 illustrates another comparison diagram of three luminance modes consistent with various embodiments of the present disclosure; and

FIG. 30 illustrates a schematic diagram of a display device consistent with various embodiments of the present disclosure.

### DETAILED DESCRIPTION

To more clearly understand objects, features and advantages of the embodiments of the present disclosure, solutions of the embodiments of the present disclosure will be further described below. Obviously, the described embodiments are only part but not all of the embodiments of the present disclosure. Based on the embodiments of the present disclosure, all other embodiments obtained by a person skilled in the art without making creative efforts fall within the scope of protection of the present disclosure.

A term used in a description of the present disclosure is for a purpose of describing specific embodiments and is not intended to limit the present disclosure. As used in herein and appended claims, singular forms “a”, “an” and “the” are intended to include plural forms as well, unless the context clearly dictates otherwise.

Although terms “first” and “second” may be used to describe XX in the embodiments of the present disclosure, XX should not be limited to the terms. The terms are only used to distinguish between different instances of XX. For example, without departing from the scope of the embodiments of the present disclosure, a first XX may also be referred to as a second XX, and similarly, a second XX may also be referred to as a first XX.

A current luminance adjustment scheme for an OLED display panel involves reducing an instantaneous luminance of an OLED device when the OLED device display panel is switched from a high-luminance mode to a low-luminance mode and reducing a luminescence time of the OLED device to lower a luminance of the OLED device. An instantaneous luminance is related to a driving current that drives the OLED device to emit light. The greater the driving current and the greater a current density, the greater the instantaneous luminance. For a Micro-LED display panel, a Micro-LED device can achieve a better luminous efficiency and uniformity at high current densities. However, reducing the current density has a more significant impact on the luminous efficiency and uniformity of the Micro-LED device. If the Micro-LED display panel adopts a traditional scheme to adjust luminance, when the Micro-LED display panel is switched from a high-luminance mode to low-luminance mode, the current density needs to be reduced, which can negatively affect the efficiency and uniformity of the display panel.

To meet application requirements of a Micro-LED display panel, driving methods for a display panel are proposed in the embodiments of the present disclosure, which can be used to adjust the luminance of the display panel. To facilitate understanding of technical solutions of the present disclosure, some terms involved in the embodiments will be explained. In terms of luminance and gray level, when an image is displayed, the display

panel has a specific luminance, while a light-emitting device adjusts the luminance according to gray level information. The display panel operates in a plurality of luminance modes. The luminance of the panel varies across the plurality of luminance modes when a same gray level is displayed. The light-emitting device can display 0-255 gray levels in each luminance mode, or in other words, the light-emitting device can display 256 luminance levels in each luminance mode. The gray levels of the display panel can also be other numbers. The present disclosure does not set a specific number limit on the luminance levels of the display panel.

For example, the display panel operates in a first luminance mode and a second luminance mode. When a same gray level is displayed, a luminance of the display panel in the first luminance mode is higher than a luminance of the display panel in the second luminance mode. The display panel displays a same gray level in the two luminance modes, that is, a same image is displayed in the two luminance modes. When the display panel displays the same image in different luminance modes, the gray level displayed by the subpixels at fixed positions remains constant. That is, when the display panel displays the same image, by adjusting a luminance adjustment module of the display panel (e.g., dragging a luminance bar), the display panel can switch between different luminance modes.

In terms of frames and subframes, the display panel displays an image as a frame, which can consist of a plurality of subframes. A subframe includes at least a writing stage and a luminescence stage. The display panel includes a plurality of scanning lines and a plurality of luminescence control lines. Each scanning line connects a plurality of subpixels, and each luminescence control line connects the plurality of subpixels. The scanning lines and the luminescence control lines drive the plurality of subpixels simultaneously, the scanning lines control a writing stage, while the luminescence control lines control a luminescence stage. In a subframe, a plurality of scanning lines of the display panel sequentially output signals from top to bottom, while a plurality of light-emitting control lines sequentially output enable signals from top to bottom. When the frame includes two or more subframes, in each subframe, the plurality of scanning lines of the display panel sequentially output enable signals from top to bottom, and the plurality of light-emitting control lines sequentially output enable signals from top to bottom. For example, when the frame consists of two subframes, luminances of a light-emitting device in the two subframes are combined to achieve a desired gray level for an image. Therefore, images displayed on the display panel in the two subframes are superimposed to form a complete image. A frame may also include only one subframe, in which case a difference between frame and subframe is nominal. In the only one subframe, the plurality of scanning lines sequentially output enable signals from top to bottom to display the complete image.

In one embodiment, a frame of the display panel includes at least one subframe, and the display panel controls the light-emitting device to display gray levels according to an instantaneous luminance allocation rule for a subframe. When the display panel switches from a high-luminance mode to a low-luminance mode, a duration of the luminescence stage of the subframe with a longest luminescence stage is reduced to lower an overall luminance of the display panel, and the overall luminance is further lowered by reducing number of subframes in a frame. When one frame includes only one subframe, the instantaneous luminance of the light-emitting device is reduced to achieve a low-luminance display on the display panel. When the display panel is switched from a high-luminance mode to a low-luminance mode, the instantaneous luminance of the light-emitting device is not reduced as much as possible, thereby ensuring that the light-emitting device operates within a range of high uniformity and high efficiency.

In one embodiment, the pixel circuits in the display panel include a pulse width modulation circuit and an amplitude modulation circuit. The pulse width modulation circuit is configured for controlling a duration of a driving current provided to the light-emitting device, while the amplitude modulation circuit is configured for controlling a magnitude of the driving current provided to the light-emitting device. The display panel controls the light-emitting device to display gray levels according to the gray level allocation rule. When the display panel is switched from the high-luminance mode to the low-luminance mode, the overall luminance of the display panel is lowered by adjusting the effective luminescence duration of the light-emitting device. In the low-luminance mode, the instantaneous luminance of the light-emitting device is reduced to achieve a low-luminance display on the display panel. When the display panel is switched from the high-luminance mode to the low-luminance mode, the instantaneous luminance of the light-emitting device is not reduced as much as possible, thereby ensuring that the light-emitting device operates within a range of high uniformity and high efficiency.

An overall technical concept of the present disclosure is outlined above, and the technical solutions of the present disclosure will be described below through specific embodiments.

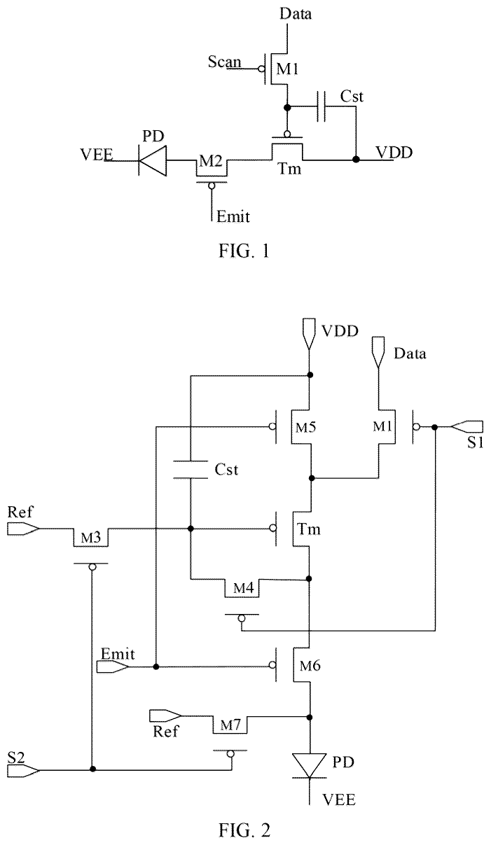

In one embodiment, a display panel includes a plurality of light-emitting devices and a plurality of pixel circuits. The plurality of light-emitting devices is coupled to the plurality of pixel circuits. FIG. 1 illustrates a schematic diagram of a pixel circuit consistent with various embodiments of the present disclosure. As illustrated in FIG. 1, the pixel circuit at least includes a driving transistor Tm, a data writing transistor M1, a light-emitting control transistor M2, and a storage capacitor Cst. A working process of the pixel circuit includes a writing stage and a luminescence stage. In the writing stage, the data writing transistor M1 is activated by a scanning signal Scan to apply a data voltage Data to a gate of the driving transistor Tm. During the luminescence stage, when the light-emitting control transistor M2 is activated by a light-emitting control signal Emit, the driving transistor Tm generates a driving current based on a gate voltage of the driving transistor Tm and supplies the driving current to a light-emitting device PD. Driving the light-emitting device PD to emit light also requires applying a first power supply voltage VDD and a second power supply voltage VEE. Optionally, the first power supply voltage VDD is a positive power supply voltage, and the second power supply voltage VEE is a negative power supply voltage. An effective pulse width of the light-emitting control signal Emit affects a duration of the luminescence stage, which in turn affects an actual light-emitting time of the light-emitting device PD. By adjusting the effective pulse width of the light-emitting control signal Emit, the duration of the luminescence stage can be controlled.

FIG. 2 illustrates a schematic diagram of another pixel circuit consistent with various embodiments of the present disclosure. As illustrated in FIG. 2, the pixel circuit includes a driving transistor Tm, a data writing transistor M1, a gate reset transistor M3, a threshold compensation transistor M4, an electrode reset transistor M7, a first light-emitting control transistor M5, a second light-emitting control transistor M6 and a storage capacitor Cst. The working process of the pixel circuit at least includes a reset stage, a writing stage and a luminescence stage. In the reset stage, the gate reset transistor M3 is activated by a second scanning signal S2 and applies a reset signal Ref to the gate of the driving transistor Tm. The electrode reset transistor M7 is activated by the second scanning signal S2 and applies the reset signal Ref to an electrode of the light-emitting device PD. In the writing stage, the data writing transistor M1 and the threshold compensation transistor M4 are activated by a first scanning signal S1 and applies to the data voltage Data to the gate of the driving transistor Tm and performs a self-test and compensation on a threshold voltage of the driving transistor Tm. In the luminescence stage, the first light-emitting control transistor M5 and the second light-emitting control transistor M6 are activated by the light-emitting control signal Emit, and the driving transistor Tm generates a driving current based on the gate voltage of the driving transistor Tm and supplies the driving current to the light-emitting device PD. The effective pulse width of the light-emitting control signal Emit affects the duration of the luminescence stage, which in turn affects the actual light-emitting time of the light-emitting device PD. By adjusting the effective pulse width of the light-emitting control signal Emit, the duration of the luminescence stage can be controlled.

The pixel circuits in FIGS. 1 and 2 are only schematic representations and are not intended to limit the scope of the present disclosure. The pixel circuit in the display panel can be any circuit capable of regulating the duration of the luminescence stage during an operation of the pixel circuit.

In the display panel, one frame includes at least one subframe, and the working process of the pixel circuit in a subframe includes at least a writing stage and a luminescence stage. In a subframe, a data voltage Data is written to the gate of the driving transistor Tm during the writing stage, and the driving transistor Tm generates a driving current and supplies the driving current to the light-emitting device PD in the luminescence stage. The light-emitting device PD emits light under a control of the driving current. An instantaneous luminance of the light-emitting device PD is related to the driving current. The greater the driving current and a current density, the higher the instantaneous luminance. The magnitude of the driving current is related to the data voltage Data. Therefore, the instantaneous luminance of the light-emitting device PD is related to the data voltage Data written during the writing stage. A luminance of the light-emitting device PD in a subframe is related to the instantaneous luminance and the luminescence duration of the light-emitting device PD. When the instantaneous luminance of the light-emitting device PD is fixed, a longer luminescence duration results in a higher luminance of the light-emitting device PD within the subframe. When a frame includes two or more subframes, a superposition of luminances of the light-emitting device PD in the two or more subframes determines a gray level displayed in the frame.

The display panel includes a plurality of luminance modes. In each luminance mode, the light-emitting device PD can display gray levels ranging from 0 to 255. A gray level displayed by the light-emitting device is controlled using an instantaneous luminance allocation rule in a subframe. The instantaneous luminance allocation rule for the subframe states that the gray level displayed by the light-emitting device PD increases with the instantaneous luminance of the light-emitting device PD in the subframe, and once the light-emitting device PD reaches a maximum instantaneous luminance in a current subframe, the light-emitting device PD is allocated to emit light in a next subframe. A duration of the luminescence stage in the next subframe is not less than a duration of the luminescence stage in the current subframe. Each subframe corresponds to a maximum instantaneous luminance of each subframe. When a maximum gray level is displayed, the light-emitting device PD reaches a corresponding maximum instantaneous luminance of the light-emitting device PD in each subframe.

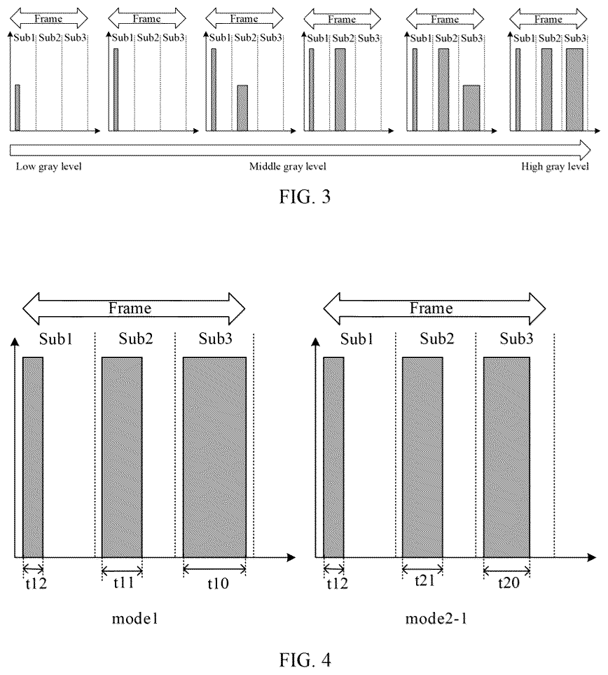

Taking one frame including three subframes as an example, the instantaneous luminance allocation rule for a subframe is explained. FIG. 3 illustrates a distribution diagram of instantaneous luminance and gray level in a subframe. In FIG. 3, an abscissa represents time, and an ordinate represents luminance. As illustrated in FIG. 3, a display process of an image is Frame, which consists of one frame including three subframes, namely Sub1, Sub2 and Sub3. A graphic filling width in FIG. 3 represents a luminescence duration of the light-emitting device PD in a subframe and represents a duration of the lighting stage in a subframe. In FIG. 3, durations of luminescence stages of Sub1, Sub2, and Sub3 gradually increase, and gray levels displayed by the light-emitting device PD also gradually increase from left to right. When the light-emitting device PD displays a low gray level, the light-emitting device PD emits light only in the subframe Sub1. As the instantaneous luminance of the light-emitting device PD in the subframe Sub1 increases, a gray level displayed by the light-emitting device PD increases. Changes in the instantaneous luminance are controlled by the data voltage Data written in the subframe Sub1. When the light-emitting device PD reaches a maximum instantaneous luminance in the subframe Sub1, the displayed gray level in the subframe Sub1 reaches a maximum gray level. To display a larger gray level, the light-emitting device PD needs to be allocated to continue to emit light in the subframe Sub2. That is, when a middle gray level is displayed, the light-emitting device PD emits light in subframe Sub1 and subframe Sub2, and in subframe Sub1, the light-emitting device PD reaches the maximum instantaneous luminance in the subframe Sub1. When the light-emitting device PD reaches the maximum instantaneous luminance in the subframe Sub1 and reaches a maximum instantaneous luminance in Sub2, the gray level displayed in the two subframes reaches a maximum gray level. The light-emitting device PD continues to emit light in the subframe Sub3 to increase the gray level that can be displayed. For example, when the light-emitting device PD displays a high gray level, the light-emitting device PD emits light in subframe Sub1, subframe Sub2, and subframe Sub3. In subframe Sub1, the light-emitting device PD reaches the maximum instantaneous luminance in the subframe Sub1. In the subframe Sub2, the light-emitting device PD reaches a maximum instantaneous luminance within the subframe Sub2. When the light-emitting device PD reaches a maximum instantaneous luminance within each of the three subframes, the light-emitting device PD can display a maximum gray level.

The above allocation rule, combined with a range of the data voltage and a required number of gray levels, is used to determine a data voltage for each subframe needed to display each gray level on the light-emitting device PD. For example, it is finally determined that if the light-emitting device PD is controlled to emit light in subframe Sub1, the light-emitting device PD can display a 0˜70 gray level, if the light-emitting device PD is controlled to emit light in subframe Sub1 and subframe Sub2, the light-emitting device PD can display a 71˜200 gray level, and if the light-emitting device PD is controlled to emit light in three subframes, the light-emitting device PD can display a 201˜255 gray level. When the light-emitting device PD displays a low gray level, priority is given to emitting light in a subframe with a shorter duration in the luminescence stage. As the display gray level increases, when the subframe with a shorter duration in the luminescence stage reaches a maximum instantaneous luminance thereof, a subframe with a longer duration in the luminescence stage is allowed to emit light. When the gray level is relatively low, the light-emitting device PD only emits light in the subframe with a shortest duration in the luminescence stage. The shorter the luminescence duration of the light-emitting device PD, the greater the current density, and the better a performance of the light-emitting device PD. Adopting the instantaneous luminance allocation rule for a subframe, as provided by the embodiment, to allocate the light-emitting device to display different gray levels can improve a luminous efficiency of the light-emitting device, prevent deviation of the emission wavelength, and improve uniformity.

It should be noted that an instantaneous luminance of a light-emitting device generally refers to detecting a luminance of the light-emitting device within a microsecond level. The instantaneous luminance is directly proportional to the data voltage of the light-emitting device. A range of data voltage that a display driver chip in a finished electronic device can provide is determined, that is, the data voltage written to the pixel circuit has a maximum value and a minimum value. A maximum instantaneous luminance of a light-emitting device within a subframe generally refers to an extreme value of the data voltage that causes the light-emitting device to achieve a maximum luminance in the subframe. The instantaneous luminance of the light-emitting device PD in each subframe needs to be allocated according to a gray level, and the instantaneous luminance is related to the data voltage. However, since gray levels are discontinuous, differences in the data voltage when the light-emitting device PD reaches maximum instantaneous luminance in different subframes exist during distribution, leading to variations in the maximum instantaneous luminances of the light-emitting device PD across different subframes. It can be understood that to make reasonable use of an available data voltage range, an extreme value of the data voltage is written to each subframe as much as possible to maximize the luminance of the light-emitting device PD. Although there are differences in maximum instantaneous luminances of the light-emitting device PD across different subframes, the luminances should be relatively close, and a difference in a data voltage corresponding to a maximum instantaneous luminance in each subframe will not be too significant. For example, a difference in a data voltage corresponding to a maximum instantaneous luminance in each subframe is not greater than 0.2ΔV, and ΔV is a voltage difference between a maximum value and a minimum value of the data voltage provided by the display panel.

In one embodiment, a driving method of a display panel can be used to drive the display panel in both the first luminance mode and the second luminance mode. When the display panel displays a same gray level, a luminance of the display panel in the first luminance mode is greater than a luminance of the display panel in the second luminance mode. The display panel displays a same image in the two different luminance modes, meaning a same gray level in the two different luminance modes. The same gray level can also be understood as a same gray level displayed by subpixels at fixed positions in the display panel in the two different luminance modes. When the same image is displayed, the first luminance mode has a higher luminance than the second luminance mode. The driving method of the display panel includes controlling the light-emitting device PD to display gray levels according to the instantaneous luminance allocation rule for the subframes in both the first luminance mode and the second luminance mode.

The frame of the display panel includes N subframes in the first luminance mode, where N is an integer, and N≥2. Optionally, at least two of the N subframes have different durations in the luminescence stage; or all the N subframes have different durations of the luminescence stage. In the second luminance mode, the frame of the display panel includes M subframes, where M is an integer, and N≥M≥1; that is, number of subframes included in a next frame in the second luminance mode is less than or equal to number of subframes in the next frame of the first luminance mode. A maximum duration of the luminescence stage in N subframes in the first luminance mode is t10, which is greater than a maximum duration of the luminescence stage in M subframes in the second luminance mode. That is, the duration of the luminescence stage in a subframe with a longest luminescence stage in the second luminance mode is shorter than the duration of the luminescence stage in the subframe with the longest luminescence stage in the first luminance mode. When M=N, a luminescence duration of the subframe with the longest luminescence stage is reduced in the second luminance mode. When M<N, number of subframes included in a frame is reduced in the second luminance mode.

In the embodiment, the driving method of the display panel controls the light-emitting device to display gray levels according to the instantaneous luminance allocation rule for a subframe in each luminance mode. When the display panel displays different luminance modes, the overall luminance of the display panel is lowered by reducing the luminescence duration of the subframe with the longest luminescence stage, or by reducing number of subframes included in a frame, rather than simply reducing the instantaneous luminance of the light-emitting device. Adopting the embodiment can ensure that the light-emitting device operates in a range of high uniformity and efficiency, thereby ensuring the efficiency and uniformity of the display panel.

In one embodiment, a duration of the luminescence stage is affected by an effective pulse width of a light-emitting control signal Emit. Specifically, in each luminance mode, the duration of the luminescence stage is determined by measuring the effective pulse width of the light-emitting control signal Emit in the subframe.

In one embodiment, the second luminance mode includes a first sub-luminance mode. In the first luminance mode, a duration of the luminescence stage in a N-th subframe among the N subframes sorted by duration is t10, and the duration of the luminescence stage in a (N−1)-th subframe is t11. In the first sub-luminance mode, where M=N, a duration of the luminescence stage in a M-th subframe among the M subframes sorted by duration is t20, and the duration of the luminescence stage in a (M−1)-th subframe is t21, t10>t20, and t11≥t21.

FIG. 4 illustrates a comparison diagram of the first luminance mode and a first sub-luminance mode consistent with various embodiments of the present disclosure. FIG. 4 illustrates a luminance distribution of each subframe when a maximum gray level is displayed in the first luminance mode and the first sub-luminance mode. When the maximum gray level is displayed, the light-emitting device reaches a maximum instantaneous luminance in each subframe. One frame including three subframes is taken as an example, where M=N=3. In FIG. 4, an abscissa represents time, and an ordinate represents luminance. As illustrated in FIG. 4, in a first luminance mode mode1 and a first sub-luminance mode mode2-1, one frame includes three subframes. The three subframes sorted by duration are a first subframe Sub1, a second subframe Sub1 and a third subframe Sub3. In the first luminance mode mode1, the third subframe Sub3 is a subframe with a longest luminescence stage, and a duration of the luminescence stage in the third subframe Sub3 is t10. A duration of the luminescence stage in the second subframe Sub2 is t11, and t11<t10. In the first sub-luminance mode mode2-1, the duration of the luminescence stage in the third subframe Sub3 is t20, and the duration of the luminescence stage in the second subframe Sub2 is t21, t21<t20. Optionally, a duration of the luminescence stage in the first subframe Sub1 in the first luminance mode mode1 and a duration of the luminescence stage in the first subframe Sub1 in the first sub-luminance mode mode2-1 are both t12, t12<t11<t10. As can be seen from FIG. 4, t10>t20, t11=t21. In one embodiment, t10>t20 and t11>t21 may also be satisfied. The driving method described in the embodiment does not change number of subframes included in a frame in the first luminance mode mode1, but lowers the overall luminance of the display panel by at least decreasing a luminescence duration in the subframe with a longest luminescence stage, thereby realizing a display in the first sub-luminance mode mode2-1, ensuring that the light-emitting device operates within a range of high uniformity and efficiency, and maintaining the efficiency and uniformity of the display panel.

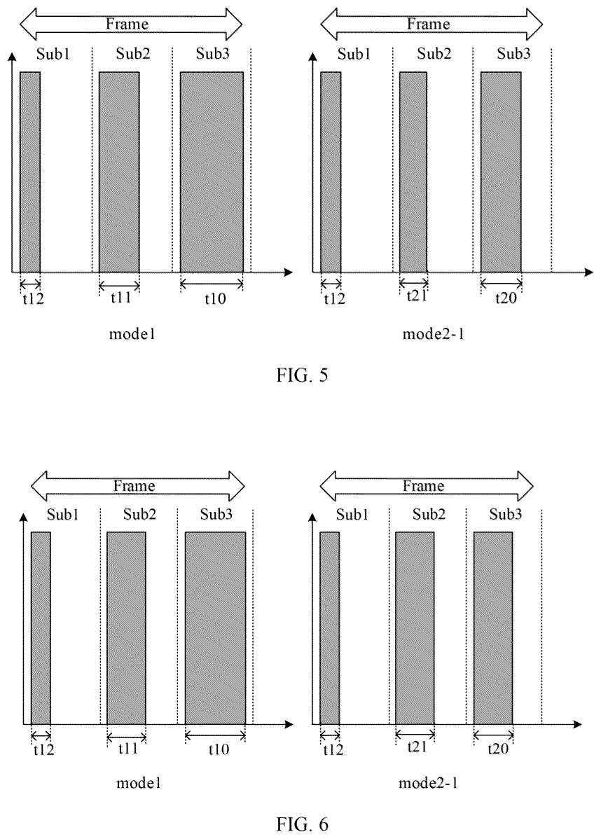

FIG. 5 illustrates another comparison diagram of the first luminance mode and the first sub-luminance mode consistent with various embodiments of the present disclosure. FIG. 5 illustrates the luminance distribution of each subframe when a maximum gray level is displayed in two luminance modes. A display of one frame including three subframes is taken as an example, where M=N=3. As illustrated in FIG. 5, in the first luminance mode and the first sub-luminance mode, the three subframes sorted by duration are the first subframe Sub1, the second subframe Sub2, and the third subframe Sub3. In the first luminance mode mode1, the duration of the luminescence stage in the third subframe Sub3 is t10, the duration of the luminescence stage of the second subframe Sub2 is t11, and the duration of the luminescence stage in the first subframe Sub1 is t12. In the first sub-luminance mode mode2-1, the duration of the luminescence stage in the third subframe Sub3 is t20, the duration of the luminescence stage in the second subframe Sub2 is t21, and the duration of the luminescence stage of the first subframe Sub1 is t12, t10>t20, and t21<t11=t20. In one embodiment illustrated in FIG. 5, the first sub-luminance mode mode2-1 is derived from the first luminance mode mode1, by reducing the duration of the luminescence stage in the third subframe Sub3 in the first luminance mode mode1. The duration of the luminescence stage in the third subframe Sub3 is shorter than the duration of the luminescence stage in the second subframe Sub2 in the first luminance mode mode1 after the reduction. In FIG. 5, the three subframes in the first sub-luminance mode mode2-1 are also sorted by duration, and durations of the luminescence stage in the three subframes are different with t12<t21<t20. Compared to the first luminance mode mode1, the first sub-luminance mode mode2-1 also lowers the overall luminance of the display panel by decreasing the duration of the luminescence stage in a subframe.

The embodiments illustrated in FIGS. 4 and 5 can be applied in combination, and the second luminance mode includes both the first sub-luminance mode mode2-1 illustrated in FIG. 4 and the first sub-luminance mode mode2-1 illustrated in FIG. 5. When a same gray level is displayed, a luminance of the display panel in the first sub-luminance mode mode2-1 illustrated in FIG. 4 is greater than the luminance of the display panel in the first sub-luminance mode mode2-1 illustrated in FIG. 5.

FIG. 6 illustrates another comparison diagram of the first luminance mode and a first sub-luminance mode consistent with various embodiments of the present disclosure. FIG. 6 illustrates the luminance distribution of each subframe when a maximum gray level is displayed in the first luminance mode and the first sub-luminance mode. A display of one frame including three subframes is taken as an example, where M=N=3. As illustrated in FIG. 6, in the first luminance mode mode1 and the first sub-luminance mode mode2-1, the three subframes sorted by duration are the first subframe Sub1, the second subframe Sub2, and the third subframe Sub3 respectively. In the first luminance mode mode1, the duration of the luminescence stage in the first subframe Sub1 is t12, the duration of the luminescence stage in the second subframe Sub2 is t11, and the duration of the luminescence stage in the third subframe Sub3 is t10. In the first sub-luminance mode mode2-1, the duration of the luminescence stage in the first subframe Sub1 is t12, the duration of the luminescence stage in the second subframe Sub2 is t21, and the duration of the luminescence stage in the third subframe Sub3 is t20, where t12<t11<t10, and t21=t11=t20. That is, in the first sub-luminance mode mode2-1, the duration of the luminescence stage in the second subframe Sub2 and the third subframe Sub3 is equal. The first sub-luminance mode mode2-1 in the embodiment illustrated in FIG. 6 can be based on the first luminance mode mode1, which reduces the duration of the luminescence stage in the third subframe Sub3 in the first luminance mode mode1, and the duration of the luminescence stage in the third subframe Sub3 after reduction is equal to the duration of the luminescence stage in the second subframe Sub2 in the first luminance mode mode1.

The embodiments illustrated in FIG. 4 and FIG. 6 can be applied in combination. The second luminance mode includes both the first sub-luminance mode mode2-1 illustrated in FIG. 4 and the first sub-luminance mode mode2-1 illustrated in FIG. 6. When the same gray level is displayed, the luminance of the display panel in the first sub-luminance mode mode2-1 illustrated in FIG. 4 is greater than the luminance of the display panel in the first sub-luminance mode mode2-1 illustrated in FIG. 6.

The embodiments illustrated in FIG. 5 and FIG. 6 can be applied in combination. The second luminance mode includes both the first sub-luminance mode mode2-1 illustrated in FIG. 5 and the first sub-luminance mode mode2-1 illustrated in FIG. 6. Since in the embodiment illustrated in FIG. 5, the duration t21 of the luminescence stage in the second subframe Sub2 in the first sub-luminance mode mode2-1 is shorter than the duration t20 of the luminescence stage in the third subframe Sub3, a luminance corresponding to the maximum gray level in the first sub-luminance mode mode2-1 in the embodiment illustrated in FIG. 5 is smaller than a luminance corresponding to the maximum gray level in the first sub-luminance mode mode2-1. In the embodiment illustrated in FIG. 6. When a same gray level is displayed, the luminance of the display panel in the first sub-luminance mode mode2-1 illustrated in FIG. 5 is smaller than the luminance of the display panel in the first sub-luminance mode mode2-1 illustrated in FIG. 6.

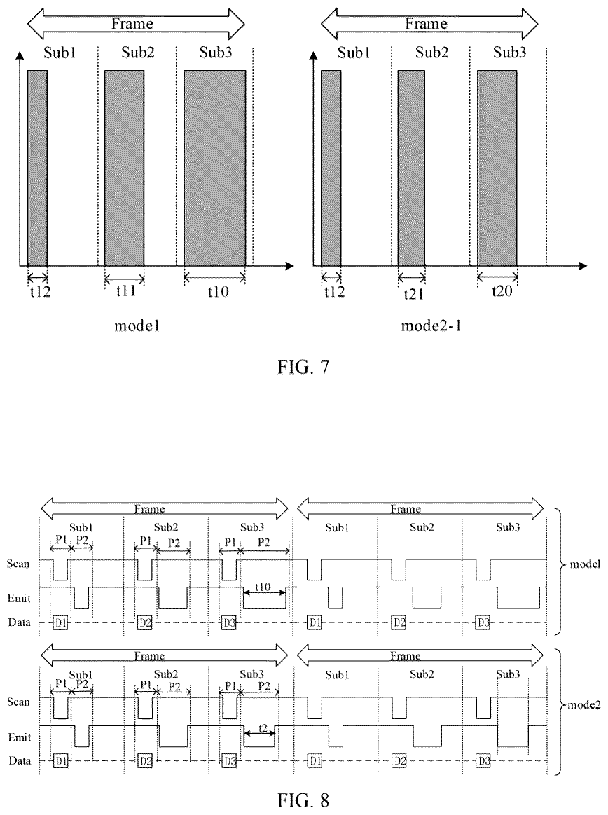

FIG. 7 illustrates another comparison diagram of the first luminance mode and a first sub-luminance mode consistent with various embodiments of the present disclosure. FIG. 7 illustrates the luminance distribution of each subframe when a maximum gray level is displayed in the first luminance mode and the first sub-luminance mode. A display of one frame including three subframes is taken as an example, where M=N=3. As illustrated in FIG. 7, in the first luminance mode mode1 and the first sub-luminance mode mode2-1, three subframes sorted by duration are the first subframe Sub1, the second subframe Sub2, and the third subframe Sub3 respectively. In the first luminance mode mode1, a relationship between luminescence durations of the three subframes is t12<t11<t10. A relationship between the luminescence durations of the three subframes in the first sub-luminance mode mode2-1 is t12<t21<t20, t21<t11, and t20<t10. In the embodiment, the first sub-luminance mode mode2-1 is derived from the first luminance mode mode1 by lowering the overall luminance of the display panel and the duration of the luminescence stage simultaneously in two subframes.

In one embodiment, N≥3. A duration of the luminescence stage in an i-th subframe sorted by duration in the first luminance mode is equal to a duration of the luminescence stage in a i-th subframe sorted by duration in the first sub-luminance mode, where i is an integer, and 1≤i<N−1. Taking N=3 in the embodiment illustrated in FIG. 4 as an example, when i=1, the duration of the luminescence stage in the first subframe Sub1 in the first luminance mode mode1 is equal to the duration of the luminescence stage in the first subframe Sub1 in the first sub-luminance mode mode12-1. When N=4 in the embodiment illustrated in FIG. 4, i can take values 1 and 2. A duration of the luminescence stage in the first subframe sorted by duration in the first luminance mode mode1 is equal to a duration of the luminescence stage in the first subframe sorted by duration under the first sub-luminance mode mode12-1, and a duration of the luminescence stage in the second subframe sorted by duration in the first luminance mode mode1 is equal to a duration of the luminescence stage in the second subframe sorted by duration in the first sub-luminance mode mode12-1. The driving method provided by the embodiment lowers the overall luminance of the display panel by reducing a duration of the luminescence stage in the subframe with a longest luminescence stage without changing the durations of the luminescence stages in the remaining subframes.

In one embodiment, the display panel includes a plurality of light-emitting control lines Emit (labeled as Emit, same as the light-emitting control signal), and the pixel circuit is coupled to the plurality of light-emitting control lines Emit. During the luminescence stage, the plurality of light-emitting control lines Emit provides effective pulses. The driving method specifies that a maximum effective pulse width of signals provided by the plurality of light-emitting control lines in N subframes in the first luminance mode is t10, where t10 is greater than a maximum effective pulse width of signals provided by the plurality of light-emitting control lines in M subframes in the second luminance mode. An effective pulse width is a width of an effective pulse signal.

FIG. 8 illustrates a timing comparison diagram of the first luminance mode and the second luminance mode consistent with various embodiments of the present disclosure. As illustrated in FIG. 8, taking N=M=3 as an example, in the first luminance mode and the second luminance mode, three subframes sorted by duration are the first subframe Sub1, the second subframe Sub2, and the third subframe Sub3. Referring to the pixel circuit illustrated in FIG. 1, the display panel is also provided with a scanning line Scan (a same label as the scanning signal Scan). The working process of the pixel circuit in each subframe includes at least a writing stage P1 and a luminescence stage P2. In FIGS. 8, D1, D2, and D3 represent data voltages Data. FIG. 8 illustrates that in the first luminance mode mode1, the effective pulse width of a signal provided by a light-emitting control lines Emit in the third subframe Sub3 is largest, assuming a low-level signal is taken as an effective signal. A maximum effective pulse width of signals is t10, which is same as the maximum duration of the luminescence stage in N subframes in the first luminance mode mode1. In the second luminance mode mode2, the effective pulse width of the signal provided by the light-emitting control line Emit in the third subframe Sub3 is largest, with a maximum effective pulse width is t2, with t10>t2. In the driving method, the effective pulse width of the light-emitting control signal Emit in a subframe determines the duration of the luminescence stage in the subframe. For example, when N=M, based on the first luminance mode mode1, by reducing an effective pulse width in a subframe with a longest effective pulse width of the light-emitting control signal Emit, the luminescence duration of the subframe with the longest duration of the luminescence stage is reduced, thereby lowering the overall luminance of the display panel and achieving the second luminance mode mode2. For example, when N>M, number of effective pulse signals provided by the light-emitting control line Emit in a next frame in the first luminance mode mode1 is greater than number of effective pulse signals provided by the light-emitting control line Emit in the next frame in the second luminance mode mode2.

The timing diagram in the second luminance mode mode2 illustrated in FIG. 8 can match the first sub-luminance mode mode2-1 illustrated in FIG. 4. In the first luminance mode mode1 and the second luminance mode mode2 illustrated in FIG. 8, the three subframes are ordered by the duration of the luminescence stage. The effective pulse width of the light-emitting control signal Emit in the first subframe Sub1 in the first luminance mode mode1 is equal to the effective pulse width of the light-emitting control signal Emit in the first subframe Sub1 in the second luminance mode mode2. The effective pulse width of the light-emitting control signal Emit in the second subframe Sub2 in the first luminance mode mode1 is equal to the effective pulse width of the light-emitting control signal Emit in the second subframe Sub2 in the second luminance mode mode2. The effective pulse width of the light-emitting control signal Emit in the third subframe Sub3 in the first luminance mode mode1 is greater than the effective pulse width of the light-emitting control signal Emit in the third subframe Sub3 in the second luminance mode mode2. Therefore, the first luminance mode mode1 and the first sub-luminance mode mode2-1 illustrated in FIG. 4 can be driven and displayed.

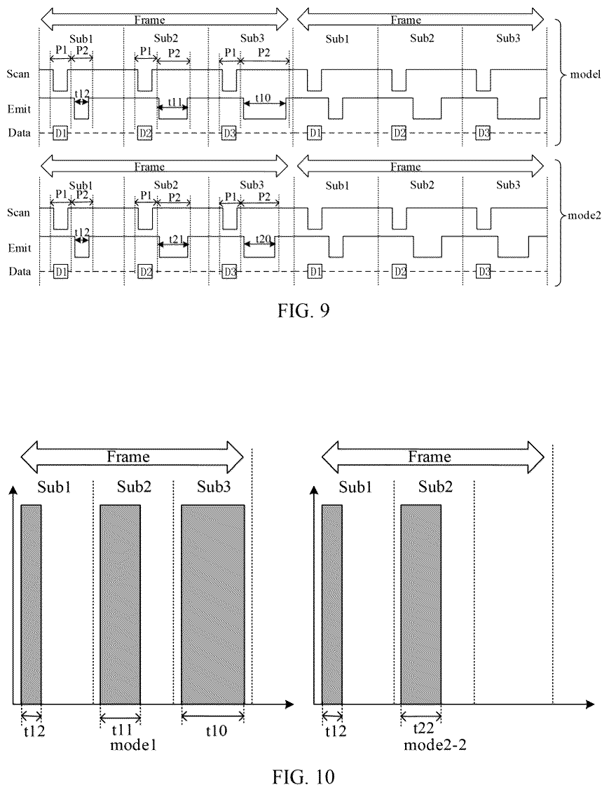

FIG. 9 illustrates another timing comparison diagram of the first luminance mode and the second luminance mode consistent with various embodiments of the present disclosure. As illustrated in FIG. 9, taking N=M=3 as an example, in the first luminance mode and the second luminance mode, the three subframes sorted by duration are the first subframe Sub1, the second subframe Sub2, and the third subframe Sub3 respectively. In the first luminance mode mode1, the effective pulse width of the light-emitting control signal Emit in the first subframe Sub1 is t12, and in the second luminance mode mode2, the effective pulse width of the light-emitting control signal Emit in the first subframe Sub1 is t12. The effective pulse width of the light-emitting control signal Emit in the second subframe Sub2 in the first luminance mode mode1 is t11, and the effective pulse width of the light-emitting control signal Emit in the second subframe Sub2 in the second luminance mode mode2 is t21, and t21=t11. The effective pulse width of the light-emitting control signal Emit in the third subframe Sub3 in the first luminance mode mode1 is t10, and the effective pulse width of the light-emitting control signal Emit in the third subframe Sub3 in the second luminance mode mode2 is t20, t20<t10, and t20=t21. The timing diagram in the second luminance mode mode2 in the embodiment can match the first sub-luminance mode mode2-1 illustrated in FIG. 6. Therefore, the first luminance mode mode1 and the first sub-luminance mode mode2-1, as illustrated in FIG. 6, can be driven and displayed.

In one embodiment, the second luminance mode includes a second sub-luminance mode. In the first luminance mode, a duration of the luminescence stage in an N-th subframe among the N subframes sorted by duration is t10. In the second sub-luminance mode, 1<M<N, a duration of the luminescence stage in an M-th subframe among the M subframes sorted by duration is t22, and t10>t22. The embodiment lowers the overall luminance of the display panel by reducing number of subframes included in a frame.

FIG. 10 illustrates a comparison diagram of the first luminance mode and the second sub-luminance mode consistent with various embodiments of the present disclosure. FIG. 10 illustrates the luminance distribution of each subframe when a maximum gray level is displayed in the first luminance mode and the second sub-luminance mode. In one embodiment, taking N=3 and M=2 as an example, as illustrated in FIG. 10, in the first luminance mode mode1, the three subframes sorted by duration are the first subframe Sub1, the second subframe Sub2, and the third subframes Sub3. In the second sub-luminance mode mode2-2, two subframes sorted by duration are the first subframe Sub1 and the second subframe Sub2 respectively. The duration of the luminescence stage in the third subframe Sub3 in the first luminance mode mode1 is t10, and the duration of the luminescence stage in the second subframe Sub2 in the second sub-luminance mode mode2-2 is t22, with t10>t22.

In addition, the duration of the luminescence stage in the second subframe Sub2 in the first luminance mode mode1 is t11, and optionally, t11>t22. When t11=t22, and the duration of the luminescence stage in the first subframe Sub1 in the first luminance mode mode1 and the duration of the luminescence stage in both the first subframe Sub1 and the second luminance mode mode2 is t12, the second sub-luminance mode mode2-2 is equivalent to reducing a subframe with a longest luminescence duration based on the first luminance mode mode1. The second sub-luminance mode mode2-2 represents a first variant of the second sub-luminance mode mode2-2. When t11>t22, and the duration of the luminescence stage in the first subframe Sub1 in both the first luminance mode mode1 and the second luminance mode mode2 is t12, the second sub-luminance mode mode2-2 is equivalent to reducing a subframe with a longest luminescence duration based on the first luminance mode mode1 and reducing the duration of the luminescence stage in the second subframe Sub2. The second sub-luminance mode mode2-2 represents a second variant of the second sub-luminance mode mode2-2. When the display panel includes the first second sub-luminance mode mode2-2 and the second sub-luminance mode mode2-2, when a same gray level is displayed, a luminance of the display panel in the first variant of the second sub-luminance mode mode2-2 is greater than a luminance of the display panel in the second variant of the second sub-luminance mode mode2-2.

In addition, the second sub-luminance mode mode2-2, as illustrated in FIG. 10 can be applied in combination with the first sub-luminance mode mode2-1 from a previously described embodiment. When the second luminance mode includes both the first sub-luminance mode mode2-1 and the second sub-luminance mode mode2-2, the luminance of the display panel in the first sub-luminance mode mode2-1 is greater than a luminance of the display panel in the second sub-luminance mode mode2-2 when a same gray level is displayed.

In one embodiment, the second sub-luminance mode mode2-2 is equivalent to reducing number of subframes in a frame based on the first luminance mode mode1. A difference between number of subframes in a next frame in the second sub-luminance mode mode2-2 and number of subframes in the next frame of the first luminance mode mode1 may be 1, 2 or 3. Specifically, the difference can be set according to the number of luminance modes that the display panel needs to display. For example, in one embodiment, N=4 in the first luminance mode mode1, and M=2 in the second sub-luminance mode mode2-2.

It should be noted that in the embodiment, the overall luminance of the display panel is lowered by reducing number of subframes included in a frame. The first luminance mode mode1 and the second sub-luminance mode mode2-2 are illustrated in FIG. 10. Although number of subframes included in a next frame of the second sub-luminance mode mode2-2 is reduced, the embodiment does not change an image refresh rate of the display panel. Therefore, it can be understood that a time required to display a frame is same in both the first luminance mode mode1 and the second sub-luminance mode mode2-2.

In one embodiment, M=N−1. Based on the first luminance mode mode1, the overall luminance of the display panel is lowered by reducing one subframe from a frame to realize the second sub-luminance mode mode2-2. Further, based on the second sub-luminance mode mode2-2, an additional subframe can be further reduced from a frame to achieve display in a lower luminance mode. The above adjustment allows the luminance modes of the display panel to be divided into more categories, thereby enhancing a user experience.

In one embodiment, a duration of the luminescence stage in a j-th subframe sorted by duration in the second sub-luminance mode mode2-2 is equal to a duration of the j-th subframe sorted by duration in the first luminance mode mode1, where j is an integer, and 1≤j≤M. As illustrated in FIG. 10, taking M=2 as an example, a duration of the luminescence stage in a first subframe sorted by duration in the second sub-luminance mode mode2-2 is equal to a duration of the luminescence stage in the first subframe sorted by duration in the first luminance mode mode1. A duration of the luminescence stage in the second subframe sorted by duration in the second sub-luminance mode mode2-2 is equal to a duration of the luminescence stage in the second subframe sorted by duration in the first luminance mode mode1. For example, when a plurality of luminance modes is set on the display panel, the luminance of the display panel gradually changes across each luminance mode when a same gray level is displayed. Using the design described above, either by adjusting the luminescence duration or reducing number of subframes can be used to design two adjacent luminance modes, which allows for a division of luminance modes into more categories, thereby enhancing a user experience.

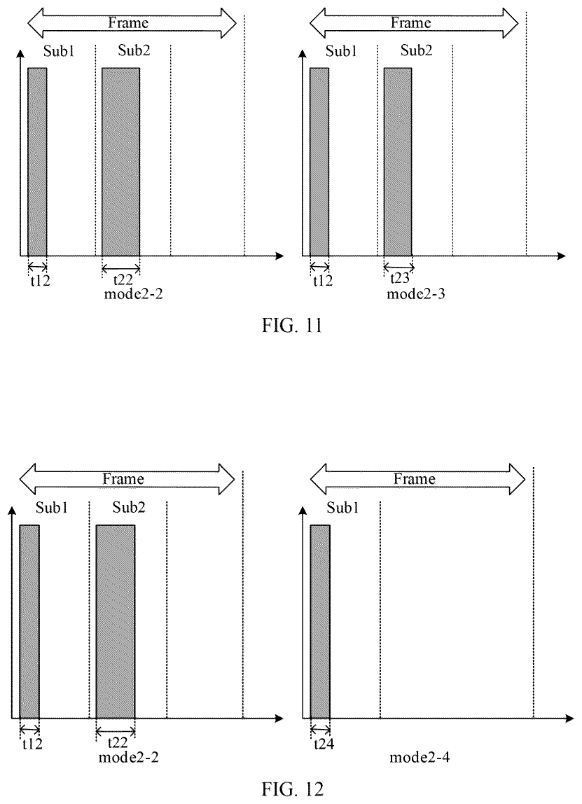

FIG. 11 illustrates a comparison diagram of the second sub-luminance mode and a third sub-luminance mode consistent with various embodiments of the present disclosure. FIG. 11 illustrates the luminance distribution of each subframe when a maximum gray level is displayed in the second sub-luminance mode and a third sub-luminance mode. In one embodiment, taking M=2 as an example, as illustrated in FIG. 11, in the second sub-luminance mode mode2-2, two subframes sorted by duration are the first subframe Sub1 and the second subframe Sub2. In a third sub-luminance mode mode2-3, two subframes sorted by duration are the first subframe Sub1 and the second subframe Sub2 respectively. A duration of the luminescence stage of the second subframe Sub2 in the second sub-luminance mode mode2-2 is t22, and a duration of the luminescence stage of the second subframe Sub2 in the third sub-luminance mode mode2-3 is t23, and t23<t22. A duration of the luminescence stage in the first subframe Sub1 in both the second sub-luminance mode mode2-2 and the third sub-luminance mode mode2-3 is t12. The embodiment achieves the third sub-luminance mode based on the second sub-luminance mode by reducing the duration of the luminescence stage in the second subframe Sub2, which can realize that when a same gray level is displayed, the luminance of the display panel in the second sub-luminance mode mode2-2 is greater than a luminance of the display panel in the third sub-luminance mode mode2-3.

In one embodiment, the second luminance mode further includes a fourth sub-luminance mode, where M=1. FIG. 12 illustrates a comparison diagram of the second sub-luminance mode and the fourth sub-luminance mode consistent with various embodiments of the present disclosure. FIG. 12 illustrates the luminance distribution of each subframe when a maximum gray level is displayed in two luminance modes. As illustrated in FIG. 12, in the second sub-luminance mode mode2-2, a next frame includes two subframes sorted by duration, which are the first subframe Sub1 and the second subframe Sub2. A duration of the luminescence stage in the first subframe Sub1 sorted by duration is t12. In a fourth sub-luminance mode mode2-4, M=1, only one subframe Sub1 is included in a frame. The duration of the luminescence stage in this subframe is t24, with t24≤t12. In the embodiment, the fourth sub-luminance mode mode2-4 is equivalent to reducing number of subframes in a frame based on the second sub-luminance mode mode2-2. When a same gray level is displayed, the luminance of the display panel in the second sub-luminance mode mode2-2 is greater than a luminance of the display panel in the fourth sub-luminance mode mode2-4.

In one embodiment, the second luminance mode includes the third sub-luminance mode mode2-3 and the fourth sub-luminance mode mode2-4. When a same gray level is displayed, the luminance of the display panel in the third sub-luminance mode mode2-3 is greater than a luminance of the display panel in the fourth sub-luminance mode mode2-4.

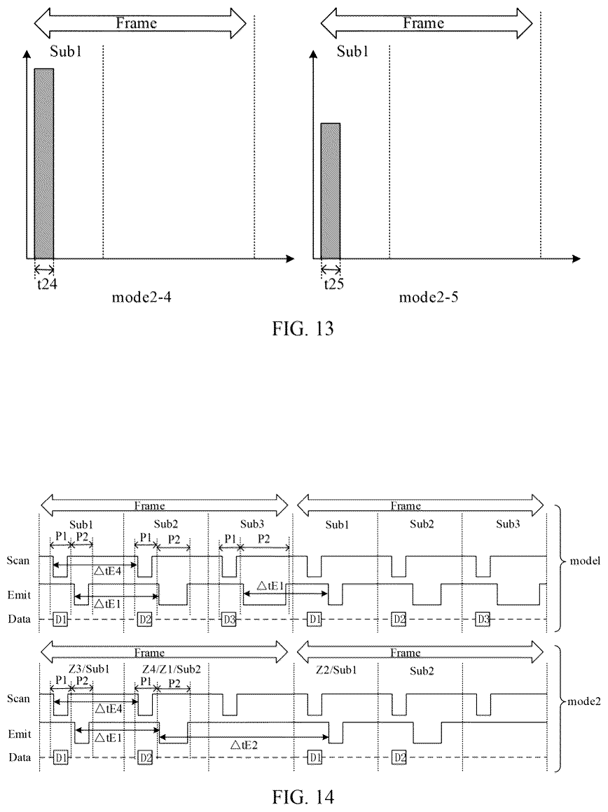

In one embodiment, the second luminance mode further includes a fifth sub-luminance mode, where M=1. When a same gray level is displayed, the luminance of the display panel in the fourth sub-luminance mode is greater than a luminance in the fifth sub-luminance mode. FIG. 13 illustrates a comparison diagram of the fourth sub-luminance mode and the fifth sub-luminance mode consistent with various embodiments of the present disclosure. FIG. 13 illustrates a luminance distribution of subframes when a maximum gray level is displayed in the fourth sub-luminance mode mode2-4 and the fifth sub-luminance mode mode2-5. As illustrated in FIG. 13, in the fourth sub-luminance mode mode2-4 and the fifth sub-luminance mode mode2-5, a next frame includes the subframe Sub1. In the fourth sub-luminance mode mode2-4, the duration of the luminescence stage in the subframe Sub1 is t24. In the fifth sub-luminance mode mode2-5, the duration of the luminescence stage in the subframe Sub1 is t25, with t25=t24. The instantaneous luminance of the light-emitting device PD when a maximum gray level is displayed in the fourth sub-luminance mode mode2-4 is greater than the instantaneous luminance of the light-emitting device PD when a maximum gray level is displayed in the fifth sub-luminance mode mode2-5.

With reference to the pixel circuit schematically illustrated in FIG. 1, it can be understood that the working process of the pixel circuit in a subframe includes a writing stage and a luminescence stage. In the writing stage, a data voltage is written to the pixel circuit, and the instantaneous luminance of the light-emitting device PD in a subframe is related to the written data voltage. In the fourth sub-luminance mode mode2-4, when the light-emitting device PD displays a maximum gray level, the data voltage written in the writing stage in the subframe is V1. In the fifth sub-luminance mode mode2-5, the duration of the luminescence stage in the subframe is t25, with t25=t24, and the data voltage written in the writing stage in the subframe when the light-emitting device PD displays the maximum gray level is V2, and V2≠V1. For example, when a driving transistor Tm in the pixel circuit is a p-type transistor, by setting V2>V1, the instantaneous luminance of the light-emitting device PD when the maximum gray level is displayed in the fourth sub-luminance mode mode2-4 can be greater than the instantaneous luminance of the light-emitting device PD when the maximum gray level is displayed in the fifth sub-luminance mode mode2-5. When the driving transistor Tm in the pixel circuit is an n-type transistor, by setting V2<V1, the instantaneous luminance of the light-emitting device PD when the maximum gray level is displayed in the fourth sub-luminance mode mode2-4 can be greater than the instantaneous luminance when the maximum gray level is displayed in the fifth sub-luminance mode mode2-5. In the low-luminance mode, when a frame of the display panel only includes one subframe, the data voltage can be adjusted to reduce the instantaneous luminance of the light-emitting device PD, thereby lowering the overall luminance of the display panel.

In the driving method, a frame of the display panel includes at least one subframe. The display panel controls the light-emitting device to display gray levels according to the instantaneous luminance allocation rule for a subframe. When the display panel is switched from the high-luminance mode to the low-luminance mode, instead of changing number of subframes included in a frame, the overall luminance of the display panel is lowered by reducing the duration of the luminescence stage in a subframe with a longest luminescence stage in the frame. To further lower the overall luminance, number of subframes in the frame can be reduced by gradually decreasing the luminescence duration in a subframe with a longest initial luminescence duration to zero, which is equivalent to reducing one subframe. After reducing number of subframes in the frame, the overall luminance of the display panel can still be lowered by decreasing a duration of the luminescence stage in the subframe with a longest luminescence stage among the remaining subframes. After reducing the number of subframes in the frame, when the frame still includes at least two subframes, the overall luminance of the display panel can be lowered by further reducing the number of subframes from the frame. When the frame includes one subframe, the instantaneous luminance of the light-emitting device is lowered to achieve a low-luminance display on the display panel. When the display panel is switched from the high-luminance mode to the low-luminance mode, a reduction of the instantaneous luminance of the light-emitting device is minimized, thereby ensuring that the light-emitting device operates within a range of high uniformity and efficiency.

In one embodiment, the working process of the pixel circuit includes at least a writing stage and a luminescence stage. In the writing stage, the scanning line Scan provides effective pulse signals to write the data voltages Data into the pixel circuit. In the luminescence stage, the light-emitting control line Emit provides effective pulse signals so that the pixel circuit provides a driving current to the light-emitting device PD. FIG. 14 illustrates another timing comparison diagram of the first luminance mode and the second luminance mode consistent with various embodiments of the present disclosure. Taking M<N, M=2, and N=3 as an example, FIG. 14 illustrates the writing stage P1 and the luminescence stage P2 of a pixel circuit operation. In FIGS. 14, D1, D2, and D3 represent data voltages Data written into the pixel circuit. As illustrated in FIG. 14, in the first luminance mode mode1, one frame includes three subframes, namely the first subframe Sub1, the second subframe Sub2 and the third subframe Sub3. In each subframe, the light-emitting control line Emit provides an effective pulse. A starting time interval at which the light-emitting control line Emit provides effective pulses in two adjacent subframes is ^{Δ}tE1.

In FIG. 14, a starting moment of a falling edge of an effective pulse is recorded as a starting moment of the effective pulse. In the second luminance mode mode2, one frame includes two subframes, namely the first subframe Sub1 and the second subframe Sub2. In each subframe, the light-emitting control line Emit provides an effective pulse. In the second luminance mode mode2, subframes include adjacent first subframe Z1 and second subframe Z2. A starting time interval at which the light-emitting control line Emit provides effective pulses in the first subframe Z1 and the second subframe Z2 is ^{Δ}tE2, and ^{Δ}tE2>^{Δ}tE1. The first subframe Z1 and the second subframe Z2 may belong to a same frame; or the first subframe Z1 and the second subframe may belong to different frames. FIG. 14 illustrates that the first subframe Z1 and the second subframe Z2 belong to different frames.

In the embodiment, by adjusting the starting time interval at which the light-emitting control line Emit provides effective pulses in two adjacent subframes, a time interval between two adjacent subframes can be adjusted, thereby adjusting a time interval between two adjacent luminescence stages P. Therefore, number of subframes included in a frame can be reduced, enabling an implementation of the second luminance mode that reduces number of subframes can be implemented. As illustrated in FIG. 10, the second sub-luminance mode mode2-2 in the second luminance mode can be implemented using a timing sequence illustrated in FIG. 14. The third sub-luminance mode mode2-3 illustrated in FIG. 11 and the fourth sub-luminance mode mode2-4 illustrated in FIG. 12 can be implemented using the timing sequence illustrated in FIG. 14.

FIG. 14 illustrates that the adjacent first subframe Z1 and second subframe Z2 belong to different frames. In the second luminance mode mode2, the light-emitting control line Emit is set to lengthen a starting time interval of providing effective pulses in the first subframe Z1 and the second subframe Z2. In one embodiment, the first subframe Z1 and the second subframe Z2 belong to a same frame, and the display of the second luminance mode mode2 is realized by adjusting the starting time interval at which the light-emitting control line Emit provides effective pulses in two adjacent subframes within a frame.

In one embodiment, the driving method includes ensuring that a period during which the scanning line Scan provides effective pulses in the first luminance mode mode1 is equal to a period during which the scanning line Scan provides effective pulses in the second luminance mode mode2, and in the second luminance mode mode2, between the writing stages of the first and second subframe, the scanning line Scan provides effective pulses, and the data line Data writes a dark state voltage or a bias voltage to the pixel circuit. As illustrated in FIG. 14, in the first luminance mode mode1, the scanning line Scan provides a starting time interval of ΔtE3 between effective pulses in any two adjacent subframes, and the scanning line Scan provides periodic pulse signals. In the second luminance mode mode2, the scanning line Scan provides a starting time interval of ΔtE4 between effective pulses in any two adjacent subframes, with ΔtE4=ΔtE3. The above implementation applies to a solution where M≥2 in the second luminance mode mode2. Compared to the first luminance mode mode1, in the second luminance mode mode2, number of subframes included in a frame is reduced not by changing the period during which the scanning line Scan provides effective pulses, but by adjusting the starting time interval at which the light-emitting control line Emit provides effective pulses in two adjacent subframes. In the embodiment illustrated in FIG. 14, within one frame in the second luminance mode mode2, the scanning line Scan has an effective pulse period and does not require a writing of the data voltage. As illustrated in FIG. 14, in a P3 period, there is no luminescence stage P2 between the P3 period and a subsequent effective pulse (or no effective pulse of the light-emitting control line Emit between two effective pulses of the scanning line Scan). That is, the P3 period is between the writing stage P1 of the first subframe Z1 and the writing stage of the second subframe Z2. During the P3 period, the scanning line Scan controls a writing of the data voltage Data, an effective pulse of the scanning line Scan activates the data writing transistor during the P3 period. The dark state voltage can be written into the pixel circuit through a data line, preventing the light-emitting device PD from emitting light until a next writing stage and luminescence stage arrive. Alternatively, for a pixel circuit like the pixel circuit illustrated in FIG. 2, the data line can be used to write a bias voltage into the pixel circuit during the P3 period to adjust a bias state of the driving transistor Tm and improve a deviations in a threshold voltage of the driving transistor Tm after prolonged use.

In one embodiment, as illustrated in FIG. 14, in the second luminance mode mode2, M≥2. The subframes in the second luminance mode mode2 include adjacent third subframe Z3 and fourth subframe Z4. A starting time interval at which the light-emitting control line Emit provides effective pulses in the third subframe Z3 and the fourth subframe Z4 is ΔtE1. The third subframe Z3 and the fourth subframe Z4 may belong to a same frame or may belong to two adjacent frames. In FIG. 14, the third subframe Z3 and the fourth subframe Z4 belong to a same frame for illustration. In the embodiment, where M≥2 in the second luminance mode mode2, subframes in the second luminance mode mode2 include the adjacent first subframe Z1 and the second subframe Z2 as well as the adjacent third subframe Z3 and the fourth subframe ZA. When M=2, since a frame only includes two subframes, naming of the first subframe Z1, the second subframe Z2, the third subframe Z3 and the fourth subframe ZA is only used to illustrate characteristics of effective pulse signals of the light-emitting control line Emit, and the naming does not limit a time sequence in the frame. As illustrated in FIG. 14, the second subframe Sub2 in the frame may be the first subframe Z1 in a relationship between the adjacent first subframe Z1 and the second subframe Z2. The second subframe Sub2 in the frame may also be the fourth subframe ZA in a relationship between the adjacent third subframe Z3 and the fourth subframe Z4. Compared to the first luminance mode mode1, the driving method adjusts starting time intervals of effective pulses provided by the light-emitting control line Emit in some pairs of adjacent subframes, while keeps starting time intervals of effective pulses provided by the light-emitting control line Emit in other pairs of adjacent subframes at ΔtE1. Therefore, number of subframes included in a frame can be reduced, enabling an implementation of the second luminance mode with fewer subframes. Moreover, the implementation is equivalent to only adjusting interval times between some adjacent effective pulses in the light-emitting control line Emit, while keeping interval times between other adjacent effective pulses unchanged, which can also facilitate coordination between the scanning line Scan and the light-emitting control line Emit. For example, the scanning line Scan can be configured to output pulse signals of a same period in both the first luminance mode mode1 and the second luminance mode mode2.

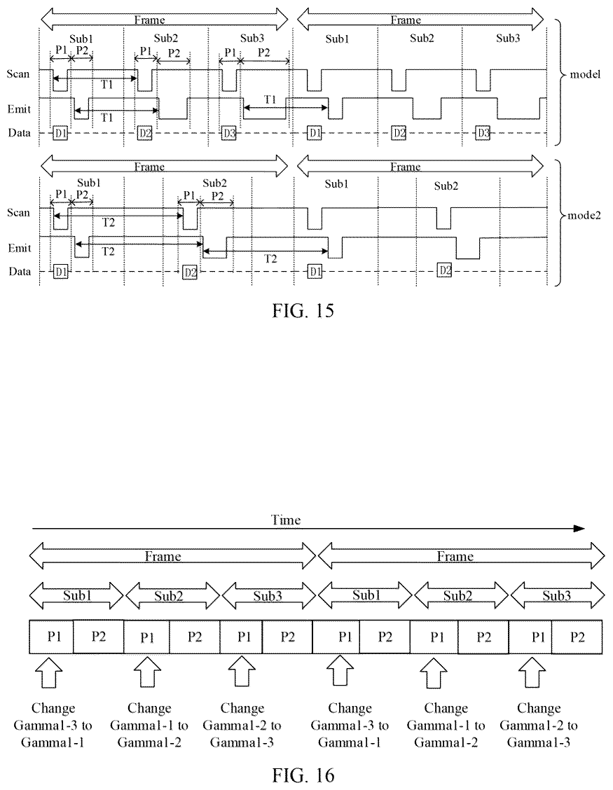

In one embodiment, FIG. 15 illustrates another timing comparison diagram of the first luminance mode and the second luminance mode consistent with various embodiments of the present disclosure. Taking M<N, M=2, and N=3 as an example, FIG. 15 illustrates the writing stage P1 and the luminescence stage P2 of the pixel circuit operation. In FIGS. 15, D1, D2, and D3 represent the writing data voltages Data. As illustrated in FIG. 15, in the first luminance mode mode1, one frame includes three subframes, namely the first subframe Sub1, the second subframe Sub2 and the third subframe Sub3. In the first luminance mode mode1, a period for which the light-emitting control line Emit provides effective pulses is T1. In FIG. 15, the period T1 is calculated based on a time interval between starting moments of two adjacent effective pulses (such as a starting falling moment of a falling edge) in the light-emitting control line Emit. Since durations of the luminescence stage in different subframes may vary, pulse widths of effective pulses provided by the light-emitting control line Emit may differ across a plurality of subframes in a frame. Therefore, it would be more accurate to calculate the period based on the time interval between the starting moments of two adjacent effective pulses in the light-emitting control line Emit. In the second luminance mode mode2, a period during which the light-emitting control line Emit provides effective pulses is T2, with T2>T1. In the above implementation, number of subframes included in a next frame in the second luminance mode mode2 is smaller than number of subframes included in the next frame in the first luminance mode mode1. In both the first luminance mode mode1 and the second luminance mode mode2, the light-emitting control line Emit provides periodic pulse signals, with T2>T1. The implementation can facilitate a generation of the light-emitting control signal on the light-emitting control line Emit, and the time interval between adjacent luminescence stages P2 in the second luminance mode mode2 becomes more uniform, enhancing the display effect in the second luminance mode mode2.

In one embodiment, as illustrated in FIG. 15, the driving method includes that: in the first luminance mode mode1, the scanning line Scan provides effective pulses for a period of T1; in the second luminance mode mode2, the scanning line Scan provides effective pulses for a period of T2. A period is calculated as a time interval between the starting moments of two adjacent effective pulses in the scanning line Scan (such as a starting falling moment of a falling edge). In the embodiment, in the first luminance mode mode1, a period during which the scanning line Scan provides effective pulses is same as a period during which the light-emitting control line Emit provides effective pulses. In the second luminance mode mode2, the period during which the scanning line Scan provides effective pulses is same as the period during which the light-emitting control line Emit provides effective pulses. The scanning line Scan and the light-emitting control line Emit work together to drive the pixel circuit to achieve display in each luminance mode.

In one embodiment, in the first luminance mode mode1, durations of the luminescence stage P2 of N subframes displayed in time sequence gradually increase or decrease; and/or, in the second luminance mode mode2, where M≥2, durations of the luminescence stage P2 of the M subframes displayed in time sequence also gradually increase or decrease. As illustrated in FIG. 14, in the first luminance mode mode1, durations of the luminescence stages P2 in the first subframe Sub1, the second subframe Sub2, and the third subframe Sub3 displayed in time sequence gradually increase. In the second luminance mode mode2, durations of the luminescence stages P2 in the first subframe Sub1 and the second subframe Sub2 displayed in time sequence gradually increase. In the embodiment, in each luminance mode, the duration of the luminescence stage of a plurality of subframes displayed in time sequence gradually changes, so that the light-emitting control line Emit provides effective pulses more regularly, thereby simplifying the driving method.

In the embodiment, to control the light-emitting device to display gray levels according to the instantaneous luminance allocation rule for the subframe, it is necessary to set a gamma curve for each subframe, and different subframes in a frame use different gamma curves.

In the first luminance mode, N subframes correspond to N first gamma curves. An n-th subframe displayed in time sequence among the N subframes uses an n-th first gamma curve, where n is an integer and 1≤n≤N. When the n-th subframe is displayed, the light-emitting device PD converts gray level information into a data voltage according to the n-th first gamma curve.

Taking N=3 as an example, FIG. 16 illustrates a schematic diagram of a driving method consistent with various embodiments of the present disclosure. FIG. 16 illustrates two frames displayed in time sequence. Each frame includes three subframes, namely the first subframe Sub1, the second subframe Sub2, and the third subframe Sub3. The first subframe Sub1 corresponds to a first piece of a first gamma curve Gamma1-1, the second subframe Sub2 corresponds to a second piece of a first gamma curve Gamma1-2, and the third subframe Sub3 corresponds to a third piece of a first gamma curve Gamma1-3. For example, when the first subframe Sub1 is displayed, the gray level information is converted into a data voltage according to the first piece of a first gamma curve Gamma1-1, in the writing stage P1, the data voltage is written to the pixel circuit, and in the luminescence stage P2, the pixel circuit supplies a driving current to the light-emitting device PD to control a light emission of the light-emitting device PD. For a light-emitting device PD, luminances of the light-emitting device PD in three subframes are superimposed to a luminance of the light-emitting device PD corresponding to the gray level in a frame.

Correspondingly, in the second luminance mode, M subframes correspond to M second gamma curves, and an m-th subframe displayed in time sequence among the M subframes includes an m-th second gamma curve, where m is an integer, and 1≤m≤M. When the m-th subframe is displayed, the light-emitting device PD converts gray level information into a data voltage according to the m-th second gamma curve. In the second luminance mode the m second gamma curves are distinct, and each subframe uses a corresponding gamma curve to convert the data voltage.

Based on a same inventive concept, another driving method of a display panel is provided in one embodiment. One frame of the display panel includes at least one subframe, and the working process of the pixel circuit in a subframe includes at least a writing stage and a luminescence stage. The pixel circuit may have a structure illustrated in FIG. 1 or FIG. 2. The display panel includes a first mode, and the driving method specifies that a subframe includes a fifth subframe and a sixth subframe in the first mode. When the light-emitting device PD displays a first gray level, the duration of the luminescence stage in the fifth subframe is t1, and the data voltage during the writing stage corresponding to the fifth subframe is V3. A duration of the luminescence stage in the sixth subframe is t2, and the data voltage during the writing stage corresponding to the sixth subframe is V4, with t1≤t2. Additionally, ∥V4|−|V3∥≤0.2^{Δ}V, where ^{Δ}V represents a voltage difference between a maximum value and a minimum value of the data voltage provided by the display panel. If the driving transistor in the pixel circuit is an n-type transistor, V3>V4, or if the driving transistor in the pixel circuit is a p-type transistor, V3<V4.

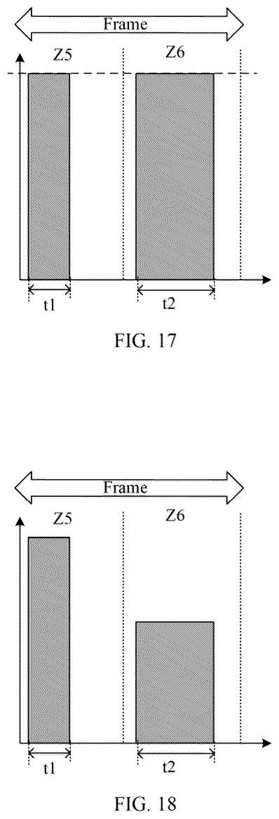

FIG. 17 illustrates a schematic diagram of a subframe status in the first mode consistent with various embodiments of the present disclosure. FIG. 18 illustrates a schematic diagram of another subframe status in the first mode consistent with various embodiments of the present disclosure. FIG. 17 and FIG. 18 both illustrate a state when the light-emitting device PD displays the first gray level. Taking the first mode as an example, one frame includes two subframes: the fifth subframe Z5 and the sixth subframe Z6. An abscissa represents time, and an ordinate represents luminance. A width of a filled graphics on the abscissa in FIGS. 17 and 18 represents the duration of the luminescence stage in a subframe.

As illustrated in FIG. 17, when the light-emitting device PD displays the first gray level in the first mode, a duration of the luminescence stage in the fifth subframe Z5 is t1, and a duration of the luminescence stage in the sixth subframe Z6 is t2, with t1<t2. The data voltage during the writing stage corresponding to the fifth subframe Z5 is V3, and the data voltage during the writing stage corresponding to the sixth subframe Z6 is V4, where V3≠V4. Additionally, ∥V4|−|V3∥≤0.2^{Δ}V, where ^{Δ}V represents a voltage difference between a maximum value and a minimum value of the data voltage provided by the display panel, meaning that an absolute different in data voltage between the fifth subframe Z5 and the sixth subframe Z6 is not greater than 20% of a data voltage amplitude (i.e. ^{Δ}V). Consequently, the difference in data voltage between the fifth subframe Z5 and the sixth subframe Z6 is small, resulting in a minimal or approximately equal instantaneous luminance difference of the light-emitting device PD in the fifth subframe Z5 and the sixth subframe Z6. When the light-emitting device PD reaches a maximum instantaneous luminance in the fifth subframe Z5, and a maximum instantaneous luminance in the sixth subframe Z6, the first gray level may represent a maximum gray level displayed by the light-emitting device PD in the first mode.

In one embodiment, ∥V4|−|V3∥<0.5V. In another embodiment, ∥V4|−|V3∥≤0.1^{Δ}V, meaning that an absolute difference in data voltage between the fifth subframe Z5 and the sixth subframe Z6 is no greater than 10% of a data voltage amplitude.

As illustrated in FIG. 18, when the light-emitting device PD displays the first gray level in the first mode, the duration of the luminescence stage in the fifth subframe Z5 is t1, and the duration of the luminescence stage in the sixth subframe Z6 is t2, and t1<t2. The data voltage during the writing stage corresponding to the fifth subframe Z5 is V3, and the data voltage during the writing stage corresponding to the sixth subframe Z6 is V4. If the driving transistor Tm in the pixel circuit is a p-type transistor, and V3<V4. When the driving transistor Tm in the pixel circuit is a p-type transistor, a smaller data voltage results in a greater driving current generated by Tm. Therefore, a driving current in the fifth subframe Z5 is greater than a driving current in the sixth subframe Z6, so that an instantaneous luminance of the light-emitting device PD in the fifth subframe Z5 is greater than an instantaneous luminance of the light-emitting device PD in the sixth subframe Z6. Correspondingly, when the driving transistor Tm in the pixel circuit is an n-type transistor, V3>V4 is set and a greater data voltage results in a greater driving current generated by Tm. Therefore, the driving current in the fifth subframe Z5 is greater than the driving current in the sixth subframe Z6, so that the instantaneous luminance of the light-emitting device PD in the fifth subframe Z5 is greater than its instantaneous luminance of the light-emitting device PD in the sixth subframe Z6. The first gray level may be a specific fixed gray level, which is not a maximum gray level.

FIG. 17 and FIG. 18 both illustrate a scenario where t1<t2. When t1=t2, one frame includes two subframes with a same luminescence duration. When t1=t2, the data voltage during the writing stage corresponding to the fifth subframe Z5 is V3, and the data voltage during the writing stage corresponding to the sixth subframe Z6 is V4. ∥V4|−|V3∥≤0.2^{Δ}V can also make an instantaneous luminance difference of the light-emitting device PD in the fifth subframe Z5 and the sixth subframe Z6 small or nearly identical. The first gray level is a maximum gray level displayed by the light-emitting device PD in the first mode. When t1=t2, the data voltage during the writing stage corresponding to the fifth subframe Z5 is V3, and the data voltage during the writing stage corresponding to the sixth subframe Z6 is V4. When the driving transistor in the pixel circuit is an n-type transistor, V3>V4, or when the driving transistor in the pixel circuit is a p-type transistor, V3<V4, an instantaneous luminance of the light-emitting device PD in the fifth subframe Z5 is greater than an instantaneous luminance of the light-emitting device PD in the sixth subframe Z6. the first gray level can represent a non-maximum gray level. When the first gray level is displayed, the shorter the duration of the subframe luminescence stage, the greater the driving current provided to the light-emitting device PD, and the greater the instantaneous luminance of the light-emitting device PD in a subframe.

In one embodiment, the driving method configures one frame of the display panel to include at least one subframe. In the first mode, the frame includes the fifth subframe Z5 and the sixth subframe Z6. The duration of the luminescence stage in the fifth subframe Z5 is arranged to be no longer than the duration of the luminescence stage in the sixth subframe Z6. A specific relationship is established between the data voltages in the fifth subframe Z5 and the sixth subframe Z6. When the first gray level is displayed in the first mode, if a difference in data voltage written by the light-emitting device between the fifth subframe Z5 and the sixth subframe Z6 is small, the light-emitting device PD achieves a maximum instantaneous luminance in the fifth subframe Z5. When the maximum instantaneous luminance is also achieved in the sixth subframe Z6, the first gray level may be the maximum gray level displayed by the light-emitting device PD in the first mode. When V3 and V4 are arranged to satisfy a specific relationship based on the type of the driving transistor Tm, the instantaneous luminance of the light-emitting device PD in the fifth subframe Z5 is greater than the instantaneous luminance of the light-emitting device PD in the sixth subframe Z6, and the first gray level can represent a non-maximum gray level.

In the embodiment, the driving method is equivalent to setting an instantaneous luminance allocation rule for a subframe. When non-maximum gray levels are displayed, for two different subframes, the driving current provided to the light-emitting device PD is higher in the subframe with a shorter luminescence stage. That is, the shorter the luminescence stage of a subframe, the higher the instantaneous luminance of the light-emitting device PD within that subframe. When the maximum instantaneous luminance is achieved in a subframe with a shorter luminescence stage, the light-emitting device is configured to emit light in a subframe with a longer luminescence stage. In addition, when the maximum gray level is displayed, the maximum driving current is provided to the light-emitting device PD in two different subframes, ensuring that the light-emitting device PD reaches the maximum instantaneous luminance of the light-emitting device PD in the two different subframes. In the embodiment, the driving method can enhance the luminous efficiency of the light-emitting device, prevent shifts in emission wavelength, and improve the uniformity.

In one embodiment, the first mode includes a first sub-mode and a second sub-mode. When a same gray level is displayed, a luminance of the display panel in the first sub-mode is greater than a luminance of the display panel in the second sub-mode. In the first sub-mode, the frame of the display panel includes N subframes, where N is an integer, N≥2, and the N subframes include the fifth subframe and the sixth subframe. In the second sub-mode, the frame of the display panel includes M subframes, where M is an integer, N≥M≥2, and the M subframes include the fifth subframe and the sixth subframe. In the first sub-mode, a maximum duration of the luminescence stage in N subframes is t70, and in the second sub-mode, a maximum duration of the luminescence stage in M subframes is t80, with t70>t80. That is, a duration of the luminescence stage in a subframe with a longest luminescence stage in the second sub-mode is shorter than a duration of the luminescence stage in the subframe with the longest luminescence stage in the first sub-mode. When M=N, the duration of the luminescence stage in the subframe with the longest luminescence stage is reduced in the second sub-mode. When M<N, number of subframes included in a frame is reduced in the second sub-mode. In the embodiment, the overall luminance of the display panel is reduced by either shortening the luminescence duration of the subframe with the longest luminescence stage, or by reducing number of subframes included in a frame, rather than by simply lowering the instantaneous luminance of the light-emitting device. In the embodiment, the light-emitting device operates within a high uniformity and high efficiency range, ensuring both the efficiency and uniformity of the display panel.

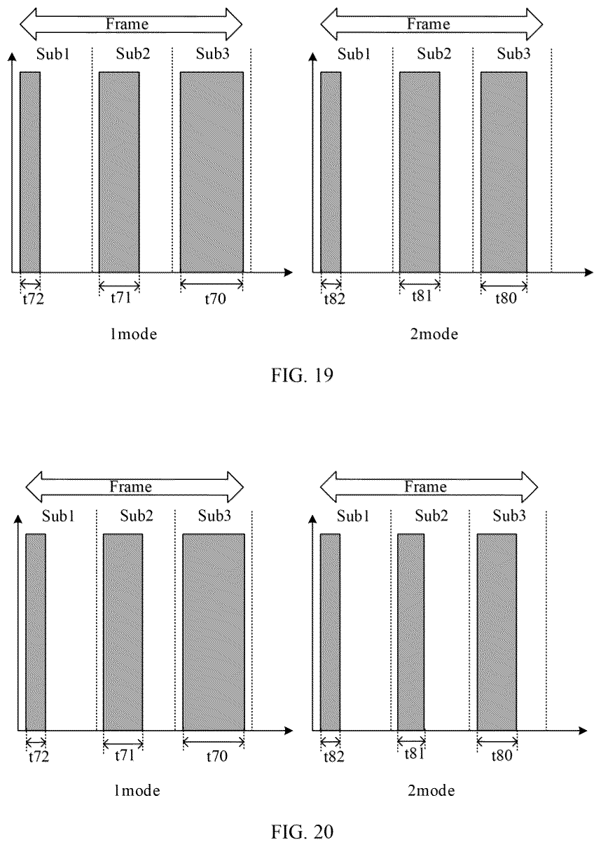

In one embodiment, taking N=3 and M=3 as an example, FIG. 19 illustrates a comparison diagram of a first sub-mode and a second sub-mode consistent with various embodiments of the present disclosure. In FIG. 19, an abscissa represents time, and an ordinate represents luminance. As illustrated in FIG. 19, in the first sub-mode 1mode, one frame of the display panel includes 3 subframes. The three subframes sorted by duration are the first subframe Sub1, the second subframe Sub2, and the third subframe Sub3, with the duration of the luminescence stage increasing progressively from Sub1 to Sub3. The three subframes include the fifth subframe Z5 and the sixth subframe Z6. For example, the second subframe Sub2 can be the fifth subframe Z5, and the third subframe Sub3 can be the sixth subframe Z6. In the second sub-mode 2mode, one frame of the display panel includes three subframes. The three subframes sorted by duration are the first subframe Sub1, the second subframe Sub2, and the third subframe Sub3. The duration of the luminescence stage increasing progressively from Sub1 to Sub3. The three subframes include the fifth subframe Z5 and the sixth subframe Z6. For example, the second subframe Sub2 can be the fifth subframe Z5, and the third subframe Sub3 can be the sixth subframe Z6; or the first subframe Sub1 can be the fifth subframe Z5, and the second subframe Sub2 can be the sixth subframe Z6.

In the first sub-mode 1mode, a maximum duration of the luminescence stage in the three subframes is t70, and in the second sub-mode 2mode, a maximum duration of the luminescence stage in the three subframes is t80, with t70>t80. A duration of the luminescence stage in the third subframe Sub3 in the first sub-mode 1mode is t70, and a duration of the luminescence stage of the third subframe Sub3 in the second sub-mode 2mode is t80. Optionally, a duration of the luminescence stage in the second subframe Sub2 in the first sub-mode 1mode is t71, and a duration of the luminescence stage in the second subframe Sub2 in the second sub-mode 2mode is t81, with t71=t81. A duration of the luminescence stage in the first subframe Sub1 in the first sub-mode 1mode is t72, and a duration of the luminescence stage of the first subframe Sub1 in the second sub-mode 2mode is t82, with t72=t82. The above implementation reduces the overall luminance of the display panel by decreasing the duration of the luminescence stage in a subframe with a longest luminescence stage.

The first sub-mode 1mode in the embodiment illustrated in FIG. 19 is equivalent to the first luminance mode mode1 in the embodiment illustrated in FIG. 4. The second sub-mode 2mode in the embodiment illustrated in FIG. 19 is equivalent to the first sub-luminance mode mode2-1 in the embodiment illustrated in FIG. 4.

In one embodiment, in the first sub-mode 1mode, the duration of the luminescence stage in an N-th subframe among the N subframes sorted by duration is t70, and a duration of the luminescence stage in an (N−1)-th subframe is t71. In the second sub-mode 2mode where M=N, the duration of the luminescence stage in an M-th subframe among the M subframes sorted by duration is t80, and a duration of the luminescence stage in an (M−1)-th subframe is t81, with t81≤t71≤t80. FIG. 19 takes M=N=3 as an example to illustrate a scenario with t81=t71<t80.

In one embodiment, t81<t71=t80. Taking N=3, M=3 as an example, FIG. 20 illustrates another comparison diagram of a first sub-mode and a second sub-mode consistent with various embodiments of the present disclosure. As illustrated in FIG. 20, in the first sub-mode 1 mode and the second sub-mode 2 mode, one frame of the display panel includes three subframes: the first subframe Sub1, the second subframe Sub2, and the third subframe Sub3 sorted by duration. In the first sub-mode 1mode, the duration of the luminescence stage in the third subframe Sub3 is t70, the duration of the luminescence stage in the second subframe Sub2 is t71, and the duration of the luminescence stage in the first subframe Sub1 is t72. In the second sub-mode 2mode, the duration of the luminescence stage in the third subframe Sub3 is t80, the duration of the luminescence stage in the second subframe Sub2 is t81, and the duration of the luminescence stage in the first subframe Sub1 is t82, t80<t70, t81<t71=t80, and t72=t82. In the embodiment illustrated in FIG. 19, the second sub-mode 2mode can be based on the first sub-mode 1mode, which reduces the duration of the luminescence stage in the third subframe Sub3 in the first sub-mode 1mode. After the duration of the luminescence stage is reduced, the duration of the luminescence stage becomes shorter than the duration of the luminescence stage in the second subframe Sub2 in the first sub-mode 1mode. The above implementation reduces the overall luminance of the display panel by decreasing the luminescence duration of a subframe with a longest luminescence stage.

It can be understood that the first sub-mode 1mode in the embodiment illustrated in FIG. 20 is equivalent to the first luminance mode mode1 in the embodiment illustrated in FIG. 5, and the second sub-mode 2mode in the embodiment illustrated in FIG. 20 is equivalent to the first sub-luminance mode mode2-1 in the embodiment illustrated in FIG. 5.

In one embodiment, in the first sub-mode 1mode, the duration of the luminescence stage in an N-th subframe among the N subframes sorted by duration is t70, and the duration of the luminescence stage in an (N−1)-th subframe is t71. In the second sub-mode 2mode, M<N, a duration of the luminescence stage in the M-th subframe among the M subframes sorted by duration is t80, with t80≤t71. The embodiment reduces the overall luminance by reducing number of subframes included in a frame.

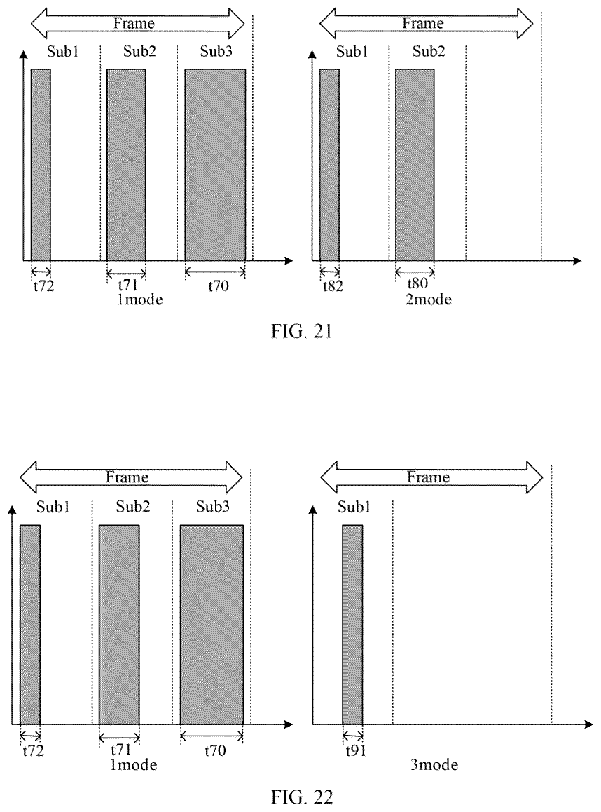

Taking N=3, M=2 as an example, FIG. 21 illustrates another comparison diagram of a first sub-mode and a second sub-mode consistent with various embodiments of the present disclosure. As illustrated in FIG. 21, in the first sub-mode 1mode, a frame of the display panel includes three subframes. The three subframes sorted by duration are the first subframe Sub1, the second subframe Sub2, and the third subframe Sub3. The first subframe Sub1, the second subframe Sub2, and the third subframe Sub3 are also sorted according to the luminescence duration. In the second sub-mode 2mode, a frame of the display panel includes two subframes. The two subframes sorted by duration are the first subframe Sub1 and the second subframe Sub2. The first subframe Sub1 and the second subframe Sub2 are also sorted by duration. In the first sub-mode 1mode, the duration of the luminescence stage in the third subframe Sub3 is t70, the duration of the luminescence stage in the second subframe Sub2 is t71, and the duration of the luminescence stage in the first subframe Sub1 is t72. In the second sub-mode 2mode, the duration of the luminescence stage of the second subframe Sub2 is t80, and the duration of the luminescence stage of the first subframe Sub1 is t82, with t80≤t71.

When t71=t80, and the duration of the luminescence stage t72 in the first subframe Sub1 in the first sub-mode 1mode is equal to the duration of the luminescence stage t82 of the first subframe Sub1 in the second sub-mode 2mode, the second sub-mode 2mode is equivalent to the first sub-mode 1mode by reducing a subframe with a longest luminescence duration, and the second sub-mode 2mode is the first second sub-mode 2mode. When t71>t80, and the duration of the luminescence stage t72 in the first subframe Sub1 in the first sub-mode 1 mode is equal to the duration of the luminescence stage t82 of the first subframe Sub1 in the second sub-mode 2mode, the second sub-mode 2mode is equivalent to reducing the subframe with the longest luminescence duration based on the first sub-mode 1mode and reducing the duration of the luminescence stage in the second subframe Sub2. The second sub-mode 2mode is the second variant of the second sub-mode 2mode. When the display panel simultaneously includes the first variant of the second sub-mode 2mode and the second variant of the second sub-mode 2mode, the luminance of the display panel in the first variant of the second sub-mode 2mode is greater than the luminance in the second variant of the second sub-mode 2mode when a same gray level is displayed.

It can be understood that the first sub-mode 1mode in the embodiment illustrated in FIG. 21 is equivalent to the first luminance mode mode1 in the embodiment illustrated in FIG. 10, and the second sub-mode 2mode in the embodiment illustrated in FIG. 21 is equivalent to the second sub-luminance mode mode2-2 in the embodiment illustrated in FIG. 10.

In one embodiment, when M<N, in the first sub-mode 1mode, one frame includes the fifth subframe and the sixth subframe. When the light-emitting device PD displays the first gray level, the data voltage during the writing stage corresponding to the fifth subframe is V31. In the second sub-mode 2mode, a frame includes the fifth subframe and the sixth subframe. When the light-emitting device PD displays the first gray level, the data voltage during the writing stage corresponding to the fifth subframe is V32, and ∥V31|−|V32∥≤0.2^{Δ}V. There is a specific relationship between the luminescence duration of the fifth subframe and the sixth subframe in the frame and the data voltage when the first gray level is displayed. The relationship between the fifth subframe and the sixth subframe needs to be understood in another mode. For example, there is no necessary connection between the luminescence duration of the fifth subframe in the first sub-mode 1mode and the luminescence duration of the fifth subframe in the second sub-mode 2mode. In one embodiment, when the light-emitting device PD displays the first gray level in the first sub-mode 1mode and the second sub-mode 2mode, a difference in absolute values of the data voltages written in the fifth subframe is minimal. When the first gray level is a maximum gray level, in both the first sub-mode 1 mode and the second sub-mode 2 mode, when the first gray level is displayed, the light-emitting device PD has a maximum driving current in the fifth subframe and reaches a maximum instantaneous luminance.

In one embodiment, in the first sub-mode 1mode, the duration of the luminescence stage in the first subframe among the N subframes sorted by duration is t72. The display panel also includes a second mode. When a same gray level is displayed, the luminance of the display panel in the first sub-mode is greater than the luminance of the display panel in the second mode. In the second mode, one frame of the display panel includes one subframe, the duration of the luminescence stage in the subframe is t91, and a corresponding data voltage when the light-emitting device displays the maximum instantaneous luminance is V5, where t91≤t72, ∥V5|−|V3∥≤0.2^{Δ}V, and/or ∥V5|−|V4∥≤0.2^{Δ}V.

Taking N=3 as an example, FIG. 22 illustrates another comparison diagram of a first sub-mode and a second sub-mode consistent with various embodiments of the present disclosure. As illustrated in FIG. 22, in the first sub-mode 1mode, one frame of the display panel includes three subframes. The three subframes sorted by duration are the first subframe Sub1, the second subframe Sub2, and the third subframe Sub3. For example, the second subframe Sub2 is the fifth subframe Z5, the third subframe Sub3 is the sixth subframe Z6, the data voltage during the writing stage corresponding to the second subframe Sub2 is V3, and the data voltage during the writing stage corresponding to the third subframe Sub3 is V4.

In the second mode 3mode, a frame of the display panel includes one subframe Sub1, the duration of the luminescence stage of subframe Sub1 is t91, and the corresponding data voltage when the light-emitting device displays the maximum gray level is V5. FIG. 22 illustrates the status of each subframe in the two modes when the first gray level is displayed, where t91≤t72, ∥V5|−|V3∥≤0.2^{Δ}V, and/or ∥V5|−|V4∥≤0.2^{Δ}V.

The second mode 3mode is the low-luminance mode displayed by the display panel. The low-luminance mode is implemented by reducing number of subframes in a frame and setting the frame to include only one subframe. In the second mode 3mode, the light-emitting device PD needs to achieve a gray level display of 0-255 to emit light in a subframe. The data voltage required to display the maximum gray level in the second mode 3mode is V5. There is little difference between V5 and V3, and little difference between V5 and V4. When the first gray level is displayed in the first sub-mode 1mode, the fifth subframe Z5 corresponds to the data voltage V3, and the sixth subframe Z6 corresponds to the data voltage V4. The first gray level may be the maximum gray level in the first sub-mode 1mode.

It can be understood that the second mode 3mode in the embodiment illustrated in FIG. 22 is equivalent to the fourth sub-luminance mode mode2-4 in the embodiment illustrated in FIG. 12.

Based on a same inventive concept, another driving method of a display panel is provided in one embodiment, which applies to a display panel in which the pixel circuit includes a pulse width modulation circuit and an amplitude modulation circuit.

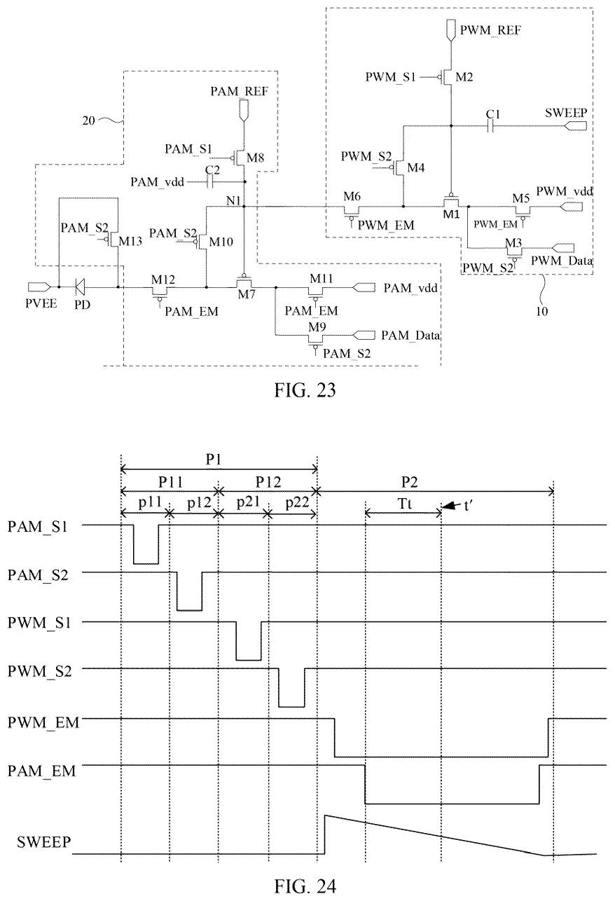

FIG. 23 illustrates a schematic diagram of another pixel circuit consistent with various embodiments of the present disclosure. FIG. 24 illustrates a timing diagram of the pixel circuit provided for an embodiment illustrated in FIG. 23. As illustrated in FIG. 23, the pixel circuit includes a first driving circuit 10 and a second driving circuit 20. The first driving circuit 10 is configured to control the duration of a driving current supplied to the light-emitting device PD based on a first data voltage PWM-data. The second driving circuit 20 is configured to control the duration of a driving current supplied to the light-emitting device PD based on a second data voltage PAM-data.

The first driving circuit 10 includes a first driving transistor M1, a first gate reset transistor M2, a first data writing transistor M3, a first compensation transistor M4, a first control transistor M6, a third control transistor M5 and a first capacitor C1. The first capacitor C1 is a storage capacitor in the first driving circuit 10 and may also referred to as a first storage capacitor in the pixel circuit. The third control transistor M5 is connected between a second power supply voltage line PWM-vdd and a first electrode of the second driving transistor M1. The first control transistor M6 is connected between a second electrode of the first driving transistor M1 and a first node N1. The first data writing transistor M3 is connected to a first electrode of the first driving transistor M1. The first compensation transistor M4 is connected to the second electrode and a gate of the first driving transistor M1. The first gate reset transistor M2 is connected to the gate of the first driving transistor M1. A first electrode of the first capacitor C1 is connected to the gate of the first driving transistor M1. A second electrode of the first capacitor C1 is connected to a frequency sweep signal terminal SWEEP. A gate of the first gate reset transistor M2 receives a third scanning signal PWM-S1. Gates of the first data writing transistor M3 and the first compensation transistor M4 receive a fourth scanning signal PWM-S2. Gates of the first control transistor M6 and the third control transistor M5 receive a first light emitting control signal PWM-EM.

The second driving circuit 20 includes a second driving transistor M7, a second gate reset transistor M8, a second data writing transistor M9, a second compensation transistor M10, a second control transistor M11, a fourth control transistor M12, an electrode reset transistor M13, and a second capacitor C2. The second control transistor M11 is connected between a first power supply voltage line PAM-vdd and a first electrode of the second driving transistor M7. The fourth control transistor M12 is connected between a second electrode of the second driving transistor M7 and a light-emitting element LD. The second driving transistor M7 is configured to generate a driving current controlled by a gate voltage of the second driving transistor M7. A gate of the second driving transistor M7 is connected to the first node N1. The second data writing transistor M9 is connected to the first electrode of the second driving transistor M7. The second compensation transistor M10 is connected to the second electrode and the gate of the second driving transistor M7. The second gate reset transistor M8 is connected to the gate of the second driving transistor M7. The electrode reset transistor M13 is connected to a first electrode of the light-emitting device PD. The fourth control transistor M12 is also connected to the first electrode of the light-emitting device PD. The second electrode of the light-emitting device PD is connected to the third power supply voltage line VEE. A gate of the second gate reset transistor M8 receives a first scanning signal PAM-S1. Gates of the second data writing transistor M9, the second compensation transistor M10 and the electrode reset transistor M13 receive a second scanning signal PAM-S2. Gates of the second control transistor M11 and the fourth control transistor M12 receive a second light emitting control signal PAM-EM.

As illustrated in FIG. 23, a first electrode of the electrode reset transistor M13 is connected to a third power supply voltage line PVE. In one embodiment, the first electrode of the electrode reset transistor M13 receives a second reset signal PAM-REF, that is, the first electrode of the electrode reset transistor M13 and a first electrode of the second gate reset transistor M8 receive a same signal. In one embodiment, the first electrode of the electrode reset transistor M13 is not connected to the third power supply voltage line PVEE. Instead, the first electrode of the electrode reset transistor M13 and the first electrode of the second gate reset transistor M8 receive different signals, which are not illustrated in the accompanying drawings.

As illustrated in FIG. 24, the working process of the pixel circuit in a frame of the display panel includes a writing stage P1 and a light emitting stage P2. The writing stage P1 is further divided into a first writing stage P11 and a second writing stage P12.

In the first writing stage P11, the second driving circuit 20 sequentially executes a gate reset stage p11 and a data writing stage p12. In the gate reset stage p11, the first scanning signal PAM-S1 is at an enable level to activate the second gate reset transistor M8, write the second reset signal PAM-REF to a gate of the second drive transistor M7, and reset the gate of the second drive transistor M7. In the data writing stage p12, the second scanning signal PAM-S2 is at an enable level to control the second data writing transistor M9, activate the second compensation transistor M10, write a second data signal PAM-Data to the gate of the second driving transistor M7 for threshold compensation, and activate the electrode reset transistor M13 to reset the electrode of the light-emitting device PD.

In the second writing stage P12, the first driving circuit 10 sequentially executes a gate reset stage p21 and a data writing stage p22. In the gate reset stage p21, the third scanning signal PWM-S1 is at an enable level to activate the first gate reset transistor M2, write a third reset signal PWM-REF into the gate of the second driving transistor M1, and reset the gate of the first driving transistor M1. In the data writing stage p22, the fourth scanning signal PWM-S2 is at an enable level to activate the first data writing transistor M3 and the first compensation transistor M4, and to write the first data signal PWM-Data to the gate of the first driving transistor M1 for threshold compensation.

The luminescence stage P2 is not a stage in which the light-emitting device PD effectively emits light. The luminescence stage includes an effective light-emitting period and a non-light-emitting period. The luminescence stage P2 can be understood as a stage where both a second light-emitting control signal PAM-EM and the first light-emitting control signal PWM-EM are at an enabled level. During the luminescence stage P2, the second light-emitting control signal PAM-EM activates the second control transistor M11 and the fourth control transistor M12. The second driving transistor M7 generates a driving current under a control of a gate voltage of the second driving transistor M7. The second driving circuit 20 provides the driving current to the light-emitting device PD. The first light emitting control signal PWM-EM activates the first control transistor M6 and the third control transistor M5. A voltage of the frequency sweep signal SWEEP, which is labeled same as the frequency sweep signal terminal SWEEP, gradually changes. A voltage of the gate of the first driving transistor M1 changes due to a coupling effect of the first capacitor C1. When a gate voltage of the first driving transistor M1 is equal to or less than a difference between absolute values of a source voltage of the first driving transistor M1 and a threshold voltage, the first driving transistor M1 is activated, and the first driving circuit 10 gradually increases a voltage of the first node N1. The second driving transistor M1 is activated to provide a second power supply voltage PWM-vdd (with a same label as the second power voltage line) to the first node N1 via the first control transistor M6, which causes the gate voltage of the first driving transistor M7 to change, leading a turn-off of the second driving transistor M7, and stopping the driving current to the light-emitting device PD. In the luminescence stage P2, a control current is generated based on a first data voltage PWM-Vdata and the frequency sweep signal SWEEP in the first driving circuit 10, and controls when the second driving circuit 20 provides the driving current, thereby adjusting the effective luminescence duration and the luminance of the light-emitting device PD.

FIG. 24 illustrates a time point t′, which marks when the second driving transistor M7 is turned off. A period between an effective pulse start time of the second light-emitting control signal PAM-EM and the time point t′ is an effective light-emitting period Tt of the light-emitting device PD.

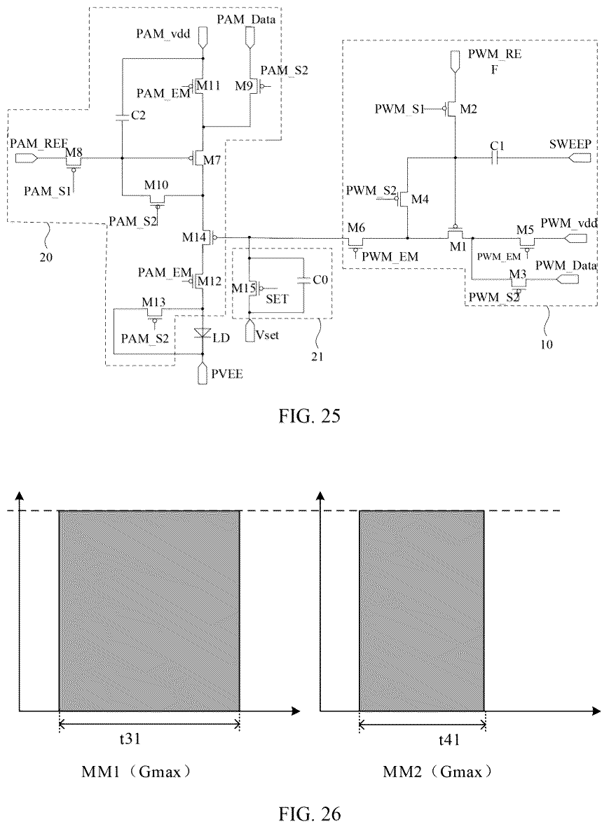

FIG. 25 illustrates a schematic diagram of another pixel circuit consistent with various embodiments of the present disclosure. Each transistor in the first driving circuit 10 and the second driving circuit 20 in FIG. 25 can be understood with reference to the embodiment illustrated in FIG. 23. As illustrated in FIG. 25, the second driving circuit 20 further includes a luminescence duration control transistor M14 electrically connected between the second driving transistor M7 and the light-emitting device PD. An output terminal of the first driving circuit 10 is electrically connected to a gate of the luminescence duration control transistor M14. In one embodiment, a driving current generated by the first driving transistor M7 can be supplied to the light-emitting device PD only when the luminescence duration control transistor M14 is activated. By controlling a turn-off of the luminescence duration control transistor M14 with the first driving circuit 10, a path between the second driving transistor M7 and the light-emitting device PD is cut off, causing the second driving circuit 20 to stop the driving current to the light-emitting device PD, thereby controlling a flow duration of the driving current.

As illustrated in FIG. 25, the second driving circuit 20 also includes a light-emitting reset circuit 21 connected between a first reset signal line Vset and the gate of the luminescence duration control transistor M14. The light-emitting reset circuit 21 is configured to reset the gate of the luminescence duration control transistor M14 using the first reset signal Vset provided by the first reset signal line Vset. A control terminal of the light-emitting reset circuit 21 is connected to the reset control line SET, which provides a reset control signal SET. Specifically, before the luminescence stage P2, the reset control line SET provides an enable signal to activate the lighting reset circuit 21, so that the first reset signal Vset resets the gate of the luminescence duration control transistor M14.

The light-emitting reset circuit 21 includes a luminescence reset transistor M15. The gate of the luminescence reset transistor M15 is connected to the reset control line SET. A first electrode of the luminescence reset transistor M15 is connected to the first reset signal line Vset. A second electrode of the luminescence reset transistor M15 is connected to the gate of the luminescence duration control transistor M14. The lighting reset circuit 21 also includes a stabilizing capacitor C0 configured for stabilizing a gate voltage of the luminescence duration control transistor M14. One electrode of the stabilizing capacitor C0 is connected to the first reset signal line Vset, and the other electrode is connected to the gate of the luminescence duration control transistor M14.

One embodiment provides a driving method of a display panel to display both the first luminance mode and the second luminance mode. When a same gray level is displayed, the luminance of the display panel in the first luminance mode is greater than the luminance of the display panel in the second luminance mode. The light-emitting device PD includes a first color light emitting device.

In one embodiment, FIG. 26 illustrates a comparison diagram of the first luminance mode and the second luminance mode consistent with various embodiments of the present disclosure. An abscissa in FIG. 26 represents time, and an ordinate represents instantaneous luminance, which illustrates the effective luminous duration and instantaneous luminance of the first color light-emitting device when a maximum gray level Gmax is displayed in the first luminance mode and the second luminance mode. As illustrated in FIG. 26, the driving method includes the following two options.

In a first luminance mode MM1, when the first color light-emitting device displays the maximum gray level Gmax, during the writing stage P1, the first data voltage written is PWM-data11, the second data voltage written is PAM-data1, and the effective luminescence duration of the luminescence stage is t31. In the first luminance mode, the light-emitting device PD is controlled to display gray levels by the gray level allocation rule. The gray level allocation rule is as follows: the second data voltage PAM-data written in the writing stage is fixed, while the gray level displayed by the light-emitting device PD varies with changes in the first data voltage PWM-data. From the above description of the working process of the pixel circuit, a change of the first data voltage PWM-data affects the effective luminescence duration of the light-emitting device PD. The first data voltage PWM-data affects the magnitude of the driving current supplied to the light-emitting device PD, which affects the instantaneous luminance of the light-emitting device PD. The gray level allocation rule controls displays of gray levels by the light-emitting device PD by adjusting a duration of the driving current provided to the light-emitting device PD without altering the magnitude of the driving current.

In a second luminance mode MM2, when the first color light-emitting device displays the maximum gray level Gmax, the first data voltage written in the writing stage P1 is PWM-data21, the second data voltage written is PAM-data2, and the effective luminescence duration of the luminescence stage P2 is t41. In the second luminance mode MM2, the light-emitting device PD is controlled to display gray levels according to the gray level allocation rule.

PWM-data21≠PWM-data11, PAM-data2=PAM-data1, t41<t31. In the first luminance mode MM1 and the second luminance mode MM2, when the first color light-emitting device displays a same gray level, the second data voltage PAM-data written to the pixel circuit remains unchanged. An effective luminescence duration of the first color light-emitting device is adjusted by varying a magnitude of the written first data voltage PWM-data, thereby adjusting luminances of the first color light-emitting device in different luminance modes. Luminances of different color light-emitting devices in the display panel can be adjusted in the above manner, thereby adjusting the overall luminance of the display panel.

The driving method provided by the embodiment maintains the second data voltage PAM-data when the display panel is switched from the high-luminance mode to the low-luminance mode. Instead, the driving method adjusts the effective luminescence duration of the light-emitting device by varying the magnitude of the first data voltage PWM-data, thereby lowering the overall luminance of the display panel. The second data voltage PAM-data affects the magnitude of the driving current and consequently, a current density. The present disclosure aims to maintain the current density when the display panel is switched from the high-luminance mode to the low-luminance mode, thereby ensuring that the light-emitting device operates within a high range of uniformity and efficiency. In the embodiment, PAM-data is a fixed signal. A size of PWM-data can be modified by adjusting a gamma curve, which controls PWM data by altering a relationship between grayscale information and data voltage, thereby regulating the brightness of the display panel. In the embodiment, the gamma control for PWM data may include a plurality of gamma curves.

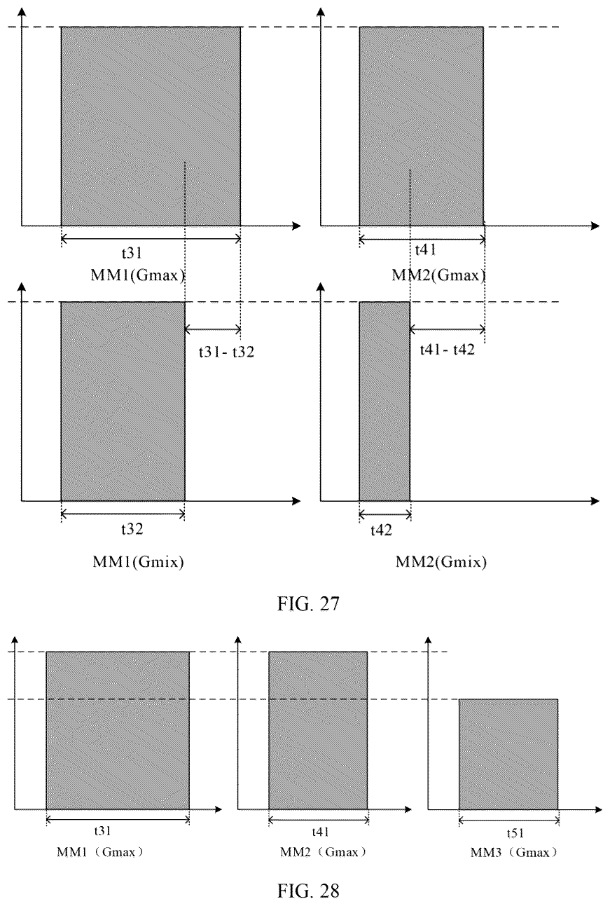

In one embodiment, FIG. 27 illustrates another comparison diagram of the first luminance mode and the second luminance mode consistent with various embodiments of the present disclosure. In FIG. 27, an abscissa represents time, and an ordinate represents instantaneous luminance. FIG. 27 illustrates the effective luminescence duration and instantaneous luminance of the first color light-emitting device when a maximum gray level is displayed, as well as the effective luminescence duration and instantaneous luminance when a minimum gray level is displayed in both the first luminance mode and the second luminance mode. Gmax represents a maximum gray level, and Gmix represents a minimum gray level. The first color light-emitting device can be a red, green, or blue light-emitting device.

As illustrated in FIG. 27, in the first luminance mode MM1, when the first color light-emitting device displays the minimum gray level Gmix, the first data voltage written in the writing stage P1 is PWM-data12, the second data voltage written is PAM-data1, so that the effective luminous duration of the luminescence stage P2 is t32. When the first color light-emitting device displays the maximum gray level Gmax, the first data voltage written in the writing stage P1 is PWM-data11, the second data voltage written is PAM-data1, and the effective luminescence duration of the luminescence stage P2 is t31. In a same luminance mode, the first color light-emitting device uses a same second data voltage for different gray levels, meaning that the light-emitting device PD is controlled to display gray levels according to the gray level allocation rule.

In the second luminance mode MM2, when the first color light-emitting device PD displays the minimum gray level, the first data voltage written in the writing stage is PWM-data22, the second data voltage written is PAM-data2, so that the effective luminescence duration of the luminescence stage is t42. When the first color light-emitting device displays the maximum gray level, the first data voltage written in the writing stage P1 is PWM-data21, the second data voltage written is PAM-data2, and the effective luminescence duration of the luminescence stage P2 is t41. In the second luminance mode MM2, the light-emitting device PD is controlled to display gray levels according to the gray level allocation rule, where PWM-data22≠PWM-data12, t42≠t32, and t41−t42>t31−t32.

In the first luminance mode MM1, by regulating the first data voltage, the effective luminescence duration of the first color light-emitting device changes between t32 and t31, thereby realizing a 0-255 gray level display of the first color light-emitting device. In the second luminance mode MM2, by regulating the first data voltage, the effective luminescence duration of the first color light-emitting device changes between t42 and t41, thereby realizing a 0-255 gray level display of the first color light-emitting device. Setting t41−t42>t31−t32 increases an adjustable range of the effective luminescence duration in the second luminance mode MM2, which can meet gray level distribution requirements at lower luminance levels, making a luminance differences between gray levels more pronounced in the second luminance mode MM2, and ensuring a clear display effect in the second luminance mode MM2.

In one embodiment, the light-emitting device PD includes a second color light-emitting device, which emits a different color from the first color light-emitting device. The driving method includes the following options.

In the first luminance mode MM1, when the first color light-emitting device performs gray level display, the second data voltage written during the writing stage P1 is PAM-data1. When the second color light-emitting device performs gray level display, the second data voltage written during the writing stage P1 is also PAM-data1.

In the second luminance mode MM2, when the first color light-emitting device performs gray level display, the second data voltage written during the writing stage P1 is PAM-data2. When the second color light-emitting device performs gray level display, the second data voltage written during the writing stage P1 is also PAM-data2, where PAM-data2=PAM-data1.

In the driving method, within a luminance mode, light-emitting devices of different colors are driven using a same second data voltage. Each light-emitting device is also driven using a same second data voltage in both the first luminance mode MM1 and the second luminance mode MM2. When the display panel is switched from the high-luminance mode to the low-luminance mode, the current density remains unchanged, ensuring that the light-emitting device operates within a range of high uniformity and efficiency. When driving display, the same second data voltage is provided to light-emitting devices of different colors, simplifying the driving method.

In one embodiment, the display panel further includes a third luminance mode. When a same gray level is displayed, the luminance of the display panel in the second luminance mode is greater than the luminance of the display panel in the third luminance mode. FIG. 28 illustrates a comparison diagram of three luminance modes consistent with various embodiments of the present disclosure. FIG. 28 illustrates the first luminance mode MM1, the second luminance mode MM2 and the third luminance mode MM3. In FIG. 28, the abscissa represents time, and the ordinate represents instantaneous luminance. FIG. 28 illustrates the effective luminescence duration and instantaneous luminance of the first color light-emitting device when the maximum gray level Gmax is displayed in the three luminance modes.

As illustrated in FIG. 28, in the first luminance mode MM1, when the first color light-emitting device displays the maximum gray level Gmax, the first data voltage written in the writing stage P1 is PWM-data11, the second data voltage written is PAM-data1, and the effective luminescence duration of the luminescence stage is t31. In the second luminance mode MM2, when the first color light-emitting device displays the maximum gray level Gmax, the first data voltage written in the writing stage P1 is PWM-data21, the second data voltage written is PAM-data2, and the effective luminescence duration of the luminescence stage P2 is t41. In the third luminance mode MM3, when the first color light-emitting device displays the maximum gray level Gmax, the first data voltage written in the writing stage P1 is PWM-data31, and the second data voltage written is PAM-data3, so that the effective luminescence duration of the luminescence stage P2 is t51. In the third luminance mode MM3, the light-emitting device PD is controlled to display gray levels according to the gray level allocation rule, which means that the first color light-emitting device uses a same second data voltage, PAM-data3, when any gray level in the third luminance mode MM3 is displayed. PAM-data3≠PAM-data1=PAM-data2, t41<t31, t51≤t31. Additionally, PWM-data21≠PWM-data11, when t51=t31, PWM-data31≠PWM-data11.

It can be seen from FIG. 28 that the instantaneous luminance of the first color light-emitting device when the maximum gray level Gmax is displayed in the third luminance mode MM3 is lower than the instantaneous luminance when the maximum gray level Gmax is displayed in the second luminance mode MM2 or the first luminance mode MM1.

In one embodiment, in the driving method, when the first color light-emitting device displays the maximum gray level, the second data voltage used in the third luminance mode MM3 differs from the second data voltage used in the second luminance mode MM2. The second data voltage affects the magnitude of the driving current, consequently, the current density. When the display panel is switched from the high-luminance mode to the low-luminance mode, the current density remains unchanged, ensuring that the light-emitting device operates within a range of high uniformity and efficiency. In the lower luminance mode, the luminance of the display panel is reduced by adjusting the second data voltage, which lowers the instantaneous luminance of the light-emitting device.

The luminance of the first color light-emitting device when the maximum gray level Gmax is displayed in the third luminance mode MM3 is lower than the luminance when the maximum gray level Gmax is displayed in the second luminance mode MM2. However, since the second data voltage used by the first color light-emitting device differs between the third luminance mode MM3 and the second luminance mode MM2 or the first luminance mode MM1, both the magnitude of the second data voltage and the effective luminescence duration will affect the luminance of the light-emitting device. By setting t51≤t31, the amplitude range of the first data voltage that a display driver chip can provide in the third luminance mode MM3 (i.e., the range between the maximum and minimum values of the first data voltage) can be guaranteed for reasonable application.

In one embodiment, the second driving circuit 20 includes a first transistor. An output terminal of the first driving circuit 20 is coupled to a gate of the first transistor. The first transistor is a p-type transistor and can be the second driving transistor M7 illustrated in FIG. 23, or the luminescence duration control transistor M14 illustrated in FIG. 25.

The driving method includes a scenario where PAM-data3>PAM-data1. That is, the second data voltage written during the writing stage when the light-emitting device displays in the third luminance mode MM3 is greater than the second data voltage written during the writing stage when the light-emitting device displays in the second luminance mode MM2 or the first luminance mode MM1. Therefore, the driving method can adapt to characteristics of the first transistor in the second driving circuit 20, adjust the current density of the light-emitting device when the light-emitting device displays in the third luminance mode MM3, and meet display requirements for the low-luminance mode.

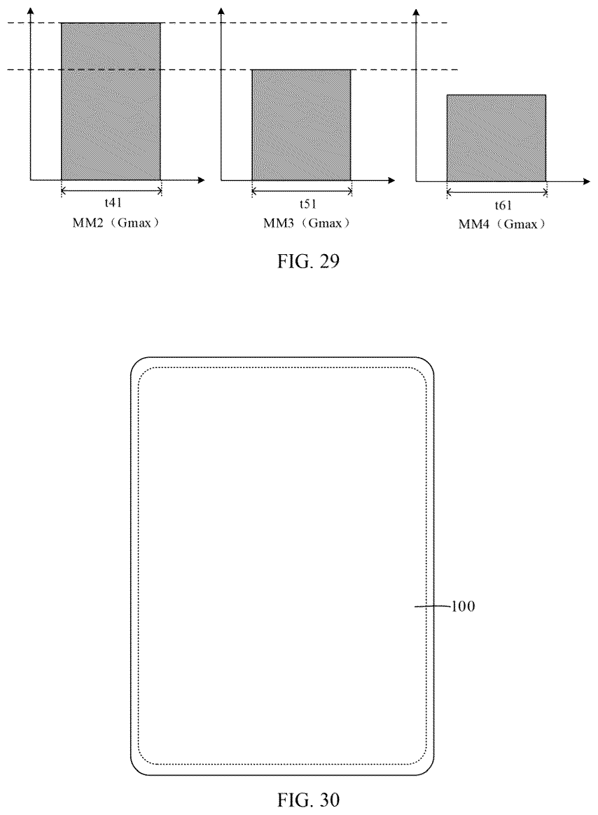

In one embodiment, the display panel further includes a fourth luminance mode. When a same gray level is displayed, the luminance of the display panel in the third luminance mode is greater than the luminance of the display panel in the fourth luminance mode. FIG. 29 illustrates another comparison diagram of three luminance modes consistent with various embodiments of the present disclosure. FIG. 29 illustrates the second luminance mode MM2, the third luminance mode MM3 and the fourth luminance mode MM4. In FIG. 29, an abscissa represents time, and an ordinate represents instantaneous luminance. FIG. 29 illustrates the effective luminescence duration and instantaneous luminance of the first color light-emitting device when the maximum gray level Gmax is displayed in the second luminance mode MM2, the third luminance mode MM3 and the fourth luminance mode MM4.

As illustrated in FIG. 29, in the second luminance mode MM2, when the first color light-emitting device displays the maximum gray level Gmax, during the writing stage P1, the first data voltage written is PWM-data21, the second data voltage written is PAM-data2, and the effective luminescence duration of the luminescence stage P2 is t41. In the third luminance mode MM3, when the first color light-emitting device displays the maximum gray level Gmax, the first data voltage written in the writing stage P1 is PWM-data31, and the second data voltage written is PAM-data3, and the effective luminescence duration of the luminescence stage P2 is t51. In the fourth luminance mode MM4, when the first color light-emitting device displays the maximum gray level Gmax, during the writing stage P1, the first data voltage written is PWM-data41, and the second data voltage written is PAM-data4, so that the effective luminescence duration of the luminescence stage P2 is t61. In the fourth luminance mode MM4, the light-emitting device PD is controlled to display gray levels according to the gray level allocation rule, where PAM-data4≠PAM-data3≠PAM-data2, t61≤t51≤t31, t41<t31. Optional, PWM-data31=PWM-data41, and t61=t51.

It can be seen from FIG. 29 that the instantaneous luminance of the first color light-emitting device when the maximum gray level Gmax is displayed in the fourth luminance mode MM4 is smaller than the instantaneous luminance of the first color light-emitting device when the maximum gray level Gmax is displayed in the third luminance mode MM3. In one embodiment, the fourth luminance mode MM4 is a luminance mode lower than the third luminance mode MM3. Based on the third luminance mode MM3, the second data voltage is further adjusted to lower the instantaneous luminance of the light-emitting device and decrease the current density, thereby reducing the overall luminance of the display panel and achieving a lower luminance mode.

In one embodiment, PAM-data and PWM-data are controlled simultaneously to adjust the brightness of the display panel and the gamma curves of PAM-data and PWM-data can also be adjusted simultaneously. That is, each of PAM-data and PWM-data can correspond to a plurality of gamma curves to regulate the brightness of the display panel. In some embodiments, the gamma curves corresponding to PAM data and/or PWM data may vary across different brightness modes of the display panel. In a same brightness mode, the gamma curves for PAM data and/or PWM data can change as the brightness adjusts.

Based on a same inventive concept, one embodiment provides a display device. FIG. 30 illustrates a schematic diagram of a display device consistent with various embodiments of the present disclosure. As illustrated in FIG. 30, the display device includes a display panel 100, which is driven using the driving method provided by any embodiment of the present disclosure. The driving method of the display panel has been detailed in the previous embodiments and will not be repeated herein. The display device provided by the embodiment may be, for example, a mobile phone, a tablet, a computer, a television, a smart wearable product, or any other electronic device with a display function.

The above are only preferred embodiments of the present disclosure and are not intended to limit the present disclosure. Any modifications, equivalent substitutions, improvements, or the like made within the spirit and principles of the present disclosure shall be included within the scope of protection of the present disclosure.

As disclosed, the driving method of a display panel and the display device provided by the present disclosure at least realize the following beneficial effects.

In some embodiments of the present disclosure, a frame of the display panel includes at least one subframe, and the display panel controls the light-emitting device to display gray levels according to the instantaneous luminance allocation rule for a subframe. When the display panel is switched from the high-luminance mode to the low-luminance mode, the duration of the luminescence stage in the subframe with a longest luminescence stage is reduced to lower the overall luminance and reduce an overall luminance by reducing number of subframes in the frame. When the frame includes one subframe, the instantaneous luminance of the light-emitting device is reduced to achieve low-luminance display on the display panel. When the display panel is switched from the high-luminance mode to the low-luminance mode, a reduction of the instantaneous luminance of the light-emitting device is minimized, thereby ensuring that the light-emitting device operates within a range of high uniformity and efficiency.

In one embodiment, the pixel circuit in the display panel includes a pulse width modulation circuit and an amplitude modulation circuit. The pulse width modulation circuit is configured to control the duration of driving current provided to the light-emitting device, and the amplitude modulation circuit is configured to control the magnitude of the driving current provided to the light-emitting device. The display panel controls the light-emitting device to display gray levels according to the gray level allocation rule. When the display panel is switched from the high-luminance mode to the low-luminance mode, the overall luminance of the display panel is lowered by adjusting the effective luminescence duration of the light-emitting device, and the instantaneous luminance of the light-emitting device is reduced to achieve a low-luminance display on the display panel in the low-luminance mode. When driving the display panel to switch from the high-luminance mode to the low-luminance mode, a reduction of the instantaneous luminance of the light-emitting device is minimized, thereby ensuring that the light-emitting device operates within a range of high uniformity and efficiency.

The above embodiments are only used to illustrate the technical solutions of the present disclosure, but not to limit the above embodiments. Although the present disclosure has been described in detail with reference to the above embodiments, a person skilled in the art should understand that he/she can still modify the technical solutions described in the above embodiments or make equivalent substitutions to some or all the technical features. However, the modifications or substitutions do not cause an essence of a corresponding technical solution to depart from the scope of the technical solutions as described in each embodiment of the present disclosure.

What is claimed is:

1. A driving method of a display panel, wherein:
the display panel includes a plurality of light-emitting devices and a plurality of pixel circuits, a frame of the display panel including at least one subframe, and a working process of a pixel circuit of the plurality of pixel circuits in a subframe of the at least one subframe at least includes a luminescence stage;
the display panel includes a first luminance mode and a second luminance mode, when the display panel displays a same gray level, a luminance of the display panel in the first luminance mode is greater than a luminance of the display panel in the second luminance mode; and
the driving method includes:
in the first luminance mode, the frame of the display panel includes N subframes, where N is an integer, and N≥2, in the first luminance mode, a light-emitting device of the plurality of light-emitting devices is controlled to display gray levels according to an instantaneous luminance allocation rule for a subframe within the N subframes,
the instantaneous luminance allocation rule for the subframe includes that a gray level of the gray levels displayed by the light-emitting device increases as an instantaneous luminance of the light-emitting device in the subframe increases, and
in the second luminance mode, the frame of the display panel includes M subframes, where M is an integer, and N≥M≥1, in the second luminance mode, a light-emitting device of the plurality of light-emitting devices is controlled to display gray levels according to the instantaneous luminance allocation rule for the subframe, a maximum duration of the luminescence stage in the N subframes in the first luminance mode is t10, and t10 is greater than a maximum duration of the luminescence stage in the M subframes in the second luminance mode.

2. The driving method according to claim 1, further comprising:
in the first luminance mode, a duration of the luminescence stage in an N-th subframe among the N subframes sorted by duration is t10, and a duration of the luminescence stage in an (N−1)-th subframe is t11;
the second luminance mode includes a first sub-luminance mode; and
in the first sub-luminance mode, where M=N, a duration of the luminescence stage in the M-th subframe among the M subframes sorted by duration is t20, and a duration of the luminescence stage in an (M−1)-th subframe is t21, with t10>t20 and t11≥t21.

3. The driving method according to claim 2, wherein t21<t11=t20, or t21=t11=t20.

4. The driving method according to claim 2, further comprising:
N≥3; and
a duration of the luminescence stage in an i-th subframe sorted by duration in the first luminance mode is equal to a duration of the luminescence stage in the i-th subframe sorted by duration in the first sub-luminance mode, where i is an integer, and 1≤i<N−1.

5. The driving method according to claim 1, wherein the display panel includes a plurality of light-emitting control lines, and the pixel circuit is coupled to the plurality of light-emitting control lines, during the luminescence stage, the plurality of light-emitting control lines provides effective pulses, the driving method further includes:
in the first luminance mode, a maximum effective pulse width of the plurality light-emitting control lines providing signals in N subframes is t10, where t10 is greater than a maximum effective pulse width of the light-emitting control line providing signals in the M subframes in the second luminance mode.

6. The driving method according to claim 1, wherein:
in the first luminance mode, a duration of the luminescence stage in an N-th subframe among the N subframes sorted by duration is t10;
the second luminance mode includes a second sub-luminance mode; and
in the second sub-luminance mode, where 1<M<N, a duration of the luminescence stage in an M-th subframe among the M subframes sorted by duration is t22, with 10>t22.

7. The driving method according to claim 6, wherein M=N−1, and the driving method further includes:
a duration of the luminescence stage in a j-th subframe sorted by duration in the second sub-luminance mode is equal to a duration of the j-th subframe sorted by duration in the first luminance mode, where j is an integer, 1≤j≤M.

8. The driving method according to claim 6, wherein:
the second luminance mode includes a third sub-luminance mode, and when a same gray level is displayed, a luminance of the display panel in the second sub-luminance mode is greater than a luminance of the display panel in the third sub-luminance mode, the driving method further includes:
in the third sub-luminance mode, where M<N, the duration of the luminescence stage in the M-th subframe among the M subframes sorted by duration is t23, with t23<t22; or
the second luminance mode includes a fourth sub-luminance mode, when a same gray level is displayed, a luminance of the display panel in the second sub-luminance mode is greater than a luminance of the display panel in the fourth sub-luminance mode, the driving method further includes:
in the second sub-luminance mode, a duration of the luminescence stage in a first subframe of the M subframes sorted by duration is t12, and
in the fourth sub-luminance mode, where M=1, a duration of the luminescence stage in a subframe is t24, with t24≤t12.

9. The driving method according to claim 6, wherein:
the display panel includes a plurality of light-emitting control lines, and the pixel circuit is coupled to the plurality of light-emitting control lines, during the luminescence stage, the plurality of light-emitting control lines provides effective pulse widths, the driving method further includes:
in the first luminance mode, a starting time interval at which the light-emitting control line provides effective pulses in two adjacent subframes is ΔtE1, and
in the second luminance mode, the subframes include adjacent first subframes and second subframes, and a starting time interval at which the light-emitting control line provides effective pulses in the first subframe and the second subframe is ΔtE2, with ΔtE2>ΔtE1.

10. The driving method according to claim 9, further comprising:
M≥2; and
in the second luminance mode, the subframes include adjacent third subframe and fourth subframe, and a starting time interval at which the light-emitting control line provides effective pulses in the third subframe and the fourth subframe is ΔtE1.

11. The driving method according to claim 9, wherein:
in the first luminance mode, a period for which the plurality of light-emitting control lines provides effective pulses is T1;
in the second luminance mode, a period for which the plurality of light-emitting control line provides effective pulses is T2, and T2>T1; and
the display panel also includes a plurality of scanning lines and a plurality of data lines, the pixel circuit is coupled to the plurality of scanning lines and the plurality of data lines respectively, a working process of the pixel circuit in a subframe also includes a writing stage, in the writing stage, the plurality of scanning lines provides effective pulses and writes data voltages provided by the plurality of data lines into the pixel circuit, the driving method further includes:
in the first luminance mode, the plurality of scanning lines provides effective pulses with a period of T1, and
in the second luminance mode, the plurality of scanning lines provides effective pulses with a period of T2.

12. The driving method according to claim 9, wherein:
the display panel also includes a plurality of scanning lines and a plurality of data lines, and the pixel circuit is coupled to the plurality of scanning lines and the plurality of data lines respectively, a working process of the pixel circuit in a subframe also includes a writing stage, in the writing stage, the plurality of scanning lines provides effective pulses, and data voltages provided by the plurality of data lines are written into the pixel circuit, the driving method further includes:
a period during which the plurality of scanning lines provides effective pulses in the first luminance mode is equal to a period during which the plurality of scanning lines provides effective pulses in the second luminance mode, and
in the second luminance mode, between the writing stages of the first subframe and the second subframe, the plurality of scanning lines provides effective pulses, and the plurality of data lines writes dark state voltages or bias voltages to the pixel circuit.

13. The driving method according to claim 1, further comprising:
in the first luminance mode, durations of the luminescence stage of N subframes displayed in time sequence gradually increase or decrease; and/or
in the second luminance mode, where M≥2, durations of the luminescence stage of M subframes displayed in time sequence gradually increase or decrease.

14. The driving method according to claim 1, further comprising:
a subframe of the at least one subframe includes a gamma curve;
in the first luminance mode, N subframes correspond to N first gamma curves, and an n-th subframe displayed in time sequence among the N subframes includes an n-th first gamma curve, where n is an integer, and 1≤n≤N, when the n-th subframe is displayed, the light-emitting device converts gray level information into a data voltage according to the nth first gamma curve; and
in the second luminance mode, M subframes correspond to M second gamma curves, and an m-th subframe displayed in time sequence among the M subframes includes an m-th second gamma curve, where m is an integer, 1≤m≤M, when the m-th subframe is displayed, the light-emitting device converts gray level information into data voltage according to the m-th second gamma curve.

15. A driving method of a display panel, wherein:
the display panel includes a plurality of light-emitting devices and a plurality of pixel circuits, the plurality of pixel circuits includes a first driving circuit and a second driving circuit, the first driving circuit is configured to control a duration of a driving current provided to the light emitting device based on a first data voltage, the second driving circuit is configured to control an amplitude of the driving current provided to the light emitting device based on a second data voltage and in a frame of the display panel, a working process of a pixel circuit of the plurality of pixel circuits includes a writing stage and a luminescence stage; and
the display panel operates in a first luminance mode and a second luminance mode, and when a same gray level is displayed, a luminance of the display panel in the first luminance mode is greater than a luminance of the display panel in the second luminance mode, the plurality of light-emitting devices includes a first color light-emitting device, and the driving method includes:
in the first luminance mode, when the first color light-emitting device displays a maximum gray level, a first data voltage written in the writing stage is PWM-data11, a second data voltage written is PAM-data1, and an effective luminescence duration of the luminescence stage is t31, in the first luminance mode, a light-emitting device of the plurality of light-emitting devices is controlled to display gray levels according to a gray level allocation rule, the gray level allocation rule includes that a second data voltage written in the writing stage is fixed, and a gray level of the gray levels displayed by the light-emitting device changes with a change of the first data voltage, and
in the second luminance mode, when the first color light-emitting device displays the maximum gray level, the first data voltage written in the writing stage is PWM-data21, the second data voltage written is PAM-data2, and the effective luminescence duration of the luminescence stage is t41, a light-emitting device of the plurality of light-emitting devices is controlled to display gray levels according to the gray level allocation rule in the second luminance mode, where PWM-data21≠PWM-data11, PAM-data2=PAM-data1, and t41<t31.

16. The driving method according to claim 15, further comprising:
in the first luminance mode, when the first color light-emitting device displays a minimum gray level, the first data voltage written in the writing stage is PWM-data12, and the second data voltage written is PAM-data1, so that the effective luminescence duration of the luminescence stage is t32; and
in the second luminance mode, when the first color light-emitting device displays the minimum gray level, the first data voltage written in the writing stage is PWM-data22, and the second data voltage written is PAM-data2, so that the effective luminescence duration of the luminescence stage is t42, where PWM-data22≠PWM-data12, and t41−t42>t31−t32.

17. The driving method according to claim 15, wherein the light-emitting device includes a second color light-emitting device, and the second color light-emitting device and the first color light-emitting device emit light in different colors, the driving method further includes:
in the first luminance mode, when the second color light-emitting device displays gray levels, the second data voltage written in the writing stage is PAM-data1; and
in the second luminance mode, when the second color light-emitting device displays gray levels, the second data voltage written in the writing stage is PAM-data2.

18. The driving method according to claim 15, wherein the display panel further includes a third luminance mode, when a same gray level is displayed, the luminance of the display panel in the second luminance mode is greater than a luminance of the display panel in the third luminance mode, the driving method further includes:
in the third luminance mode, when the first color light-emitting device displays the maximum gray level, the first data voltage written in the writing stage is PWM-data31, and the second data voltage written is PAM-data3, so that the effective luminescence duration of the luminescence stage is t51; and
the light-emitting device is controlled to display gray levels according to the gray level allocation rule in the third luminance mode, where PAM-data3≠PAM-data1, with t51≤t31.

19. The driving method according to claim 18, wherein:
a second drive circuit includes a first transistor, and an output terminal of a first drive circuit is coupled to a gate of the first transistor; the first transistor is a p-type transistor, the driving method further includes PAM-data3>PAM-data1; and
the display panel further includes a fourth luminance mode, when a same gray level is displayed, the luminance of the display panel in the third luminance mode is greater than a luminance of the display panel in the fourth luminance mode, the driving method further includes:
in the fourth luminance mode, when the first color light-emitting device displays the maximum gray level, the first data voltage written in the writing stage is PWM-data41, and the second data voltage written in the writing stage is PAM-data4, so that the effective luminescence duration of the luminescence stage is t61; and
in the fourth luminance mode, the light-emitting device is controlled to display gray-scale levels according to the gray-scale allocation rule, where PAM-data4≠PAM-data3, and t61≤t51.

20. A display device comprising a display panel driven by a method, wherein:
the display panel includes a plurality of light-emitting devices and a plurality of pixel circuits, a frame of the display panel including at least one subframe, and a working process of a pixel circuit of the plurality of pixel circuits in a subframe of the at least one subframe at least includes a luminescence stage;
the display panel includes a first luminance mode and a second luminance mode, when the display panel displays a same gray level, a luminance of the display panel in the first luminance mode is greater than a luminance of the display panel in the second luminance mode; and
the driving method includes:
in the first luminance mode, the frame of the display panel includes N subframes, where N is an integer, and N≥2, in the first luminance mode, a light-emitting device of the plurality of light-emitting devices is controlled to display gray levels according to an instantaneous luminance allocation rule for a subframe within the N subframes,
the instantaneous luminance allocation rule for the subframe includes that a gray level of the gray levels displayed by the light-emitting device increases as an instantaneous luminance of the light-emitting device in the subframe increases, and
in the second luminance mode, the frame of the display panel includes M subframes, where M is an integer, and N≥M≥1, in the second luminance mode, a light-emitting device of the plurality of light-emitting devices is controlled to display gray levels according to the instantaneous luminance allocation rule for the subframe, a maximum duration of the luminescence stage in the N subframes in the first luminance mode is t10, and t10 is greater than a maximum duration of the luminescence stage in the M subframes in the second luminance mode.
